(19) United States
(12) Patent Application Publication
(10) Pub. No.: US 2005/0086394 A1
(43) Pub. Date: Apr. 21, 2005

(54) Output device selection system, printer selection system, output device, program for output device, and output device selection method

(76) Inventors: Naruhide Kitada, Nagano-ken (JP); Hozumi Mori, Beppu-shi (JP); Mikio Aoki, Suwa-shi (JP); Taro Ishige, Beppu-shi (JP)

Correspondence Address: HARNESS, DICKEY & PIERCE, P.L.C., P.O. BOX 828, BLOOMFIELD HILLS, MI, 48303, US

(21) Appl. No.: 10/747,814

(22) Filed: Dec. 29, 2003

(30) Foreign Application Priority Data
Dec. 26, 2002 (JP) 2002-377295
Oct. 29, 2003 (JP) 2003-369239

(51) Int. Cl. G06F 3/00

(52) U.S. Cl. 710/1

(57) ABSTRACT

An output device selection system suitable for reducing the time and effort spent on installing drivers as well as for saving the user the trouble of making settings is provided. If a network printer 100 receives specialized print data which contains printing conditions indicating that printing should be done on another network printer 100, it converts the received specialized print data into intermediate print data and transfers the resulting intermediate print data to the other network printer 100. On the other hand, if the network printer 100 receives specialized print data which contains printing conditions indicating that printing should be done on the network printer 100 itself, it does printing based on the received specialized print data. However, if it receives intermediate print data, it converts the received intermediate print data into specialized print data and does printing based on the resulting specialized print data.

### BACKGROUND OF THE INVENTION

1. Field of the Invention

The present invention relates a system, device, program, and method for selecting a printer to be used for printing from among a plurality of network printers. More particularly, it relates to an output device selection system, printer selection system, output device, program for output device, and output device selection method suitable for reducing the time and effort spent on installing drivers as well as for saving the user the trouble of making settings.

2. Description of the Related Art

Conventionally, techniques for automatically selecting a printer to be used for printing from among a plurality of network printers include, for example, a printer server device disclosed in Japanese Patent Laid-Open No. 8-314653 (hereinafter referred to as the first prior art example), a printer control device disclosed in Japanese Patent Laid-Open No. 11-102270 (hereinafter referred to as the second prior art example), an image output control device disclosed in Japanese Patent Laid-Open No. 11-110159 (hereinafter referred to as the third prior art example), a print system disclosed in Japanese Patent Laid-Open No. 11-184655 (hereinafter referred to as the fourth prior art example), a print system disclosed in Japanese Patent Laid-Open No. 2002-318674 (hereinafter referred to as the fifth prior art example), and a printer control device disclosed in Japanese Patent Laid-Open No. 2002-229754 (hereinafter referred to as the sixth prior art example).

In the first prior art example, a printer supervisor in the printer server device references printer queues at regular time intervals and stores status of each printer queue in a printer information table. When a workstation sends print data to the printer server, a communications controller receives the print data and passes it to a print data controller. Upon receiving the print data, the print data controller stores the print data in a temporary queue. Then, the printer supervisor determines a printer queue which will be serviced most quickly, with reference to the printer information table, and a print data sender sends the print data in the temporary queue to the printer queue.

This makes it possible to reduce printing time because the printer which will finish printing in the shortest time is selected automatically from among a plurality of network printers connected to the printer server which in turn is connected to a network.

In the second prior art example, print data is sent out in response to a print request from a first terminal. The print data contains printing condition information and a printer control unit receives the print data via a network controller and stores it on a recording medium under the control of a recording medium controller. With reference to printer information contained in the printing condition information, a main controller selects a first printer and acquires its status information. The printing condition information and print data are stored in a job management table of the selected printer and a spool file, respectively. The main controller notifies the first terminal about start of printing and sends the print data to the first printer. Also, the main controller constantly checks for error and when an error is detected, it notifies the first terminal about conditions of the error and waits for the error to be removed. When the end of printing is confirmed, the main controller notifies the first terminal about it.

This makes it possible to print as the user desires and carry out a printing process efficiently.

The third prior art example comprises a detecting section which detects identification names and related information about connected image output devices, a registration section which registers desired image output devices out of the image output devices detected by the detecting section, together with at least part of their related information, judging section which judges whether the image output devices registered in the registration section are suitable for performing a print job, based on the related information registered in the registration section, and instruction section which instructs the image output device judged suitable by the judging section to do the print job.

This makes it possible to reduce printing time because the printer which can produce output most quickly is selected automatically from among a group of registered printers according to priorities.

The fourth prior art example comprises a terminal device, a plurality of image output devices which output images and character information from the terminal device, and a printer server which is connected with the terminal device and image output devices via a network. The printer server comprises a receiver which receives a print job from the terminal device, main controller which delivers a print job to the most suitable image output device according to printing conditions contained in the received print job, billing information section which holds billing management information about individual image output devices, fee calculator which calculates printing fees based on the billing management information and printing conditions of the print job, and device selector which calculates the print fee of each image output device and selects the image output device with the most inexpensive fee based on the results of the fee calculation. The main controller delivers the print job to the image output device selected by the device selector.

This makes it possible to reduce printing cost because the image output device which incurs the most inexpensive fee is selected automatically from among a plurality of available image output devices.

The fifth prior art example concerns a printer system consisting of a computer and a plurality of printers connected to each other via a network. It acquires the time required to start up (warm-up time) each of the printers connected to the network and automatically selects the printer with the shortest warm-up time. Also, any printer with the lowest power consumption is selected automatically.

This makes it possible to reduce printing time and printing cost because the computer selects the printer which can print most quickly or consumes the least power even in a printer system in which a plurality of printers are connected.

The six prior art example comprises a printer selector which selects from among a plurality of printers connected to a network, printer judging section which judges whether the printer selected from the printers connected to the network is available for printing, and a printer driver serving as a print data transfer section which processes print data for the selected printer and transfers it to the printer.

This makes it possible to do printing reliably because desired data is sent automatically to a printer available for printing.

In a network environment in which a plurality of network printers are connected, the user does printing by selecting a printer which supports desired print data and a desired print format. For that, the user needs to install a printer driver on his/her PC for each type of network printer to be used.

In the first to fifth prior art examples, which are designed to automatically select the printer which requires the least printing time or printing cost, if there are different types of network printers, a printer driver must be installed for each printer type, which has the problem of being troublesome. This is because each network printer is designed to receive specialized print data in a print format printable especially on the same type of devices as itself and do printing based on the received specialized print data for the purpose of improving print quality.

Although there are cases in which a printer server manages a plurality of printer drivers and does printing without being aware of the types of network printer as with the sixth prior art example, an OS (Operating System) or the like on the PC must convert printer drivers and if there is no network printer suitable for printing, the user must reconfigure printing conditions.

The present invention has been made in view of the unsolved prior art problems described above and has an object to provide an output device selection system, printer selection system, output device, program for output device, and output device selection method suitable for reducing the time and effort spent on installing drivers as well as for saving the user the trouble of making settings.

### SUMMARY OF THE INVENTION

To achieve the above object, aspect 1 is an output device selection system which communicably connects a plurality of output devices and selects one of the plurality of output devices to produce output, wherein:
a first output device from among the plurality of output devices comprises specialized output data receiving section for receiving specialized output data in an output format which can be output especially by devices of the same type as the first output device, and output section for producing output based on the specialized output data received by the specialized output data receiving section;
the output device selection system comprises output device selection section for selecting a destination output device from among the plurality of output devices, and intermediate output data transfer section for transferring intermediate output data of the specialized output data to the output device selected by the output device selection section; and
a second output device other than the first output device from among the plurality of output devices comprises intermediate output data receiving section for receiving the intermediate output data, inverse data conversion section for converting the intermediate output data received by the intermediate output data receiving section into specialized output data in an output format which can be output especially by devices of the same type as the second output device, and output section for producing output based on the specialized output data produced by the inverse data conversion section.

With this configuration, in order for an output request terminal such as a PC to request output from an output device, a driver for the first output device generates specialized output data in an output format which can be output especially by devices of the same type as the first output device and sends it to the first output device.

In the first output device, when the specialized output data receiving section receives the specialized output data, if, for example, the received specialized output data is to be output by another output device, the output device selection section selects a destination output device from among the plurality of output devices and the intermediate output data transfer section transfers intermediate output data of the specialized output data to the selected output device. On the other hand, for example, if the received specialized output data is to be output by the first output device, the output section produces output based on the received specialized output data.

In the second output device, when the intermediate output data receiving section receives the intermediate output data, the inverse data conversion section converts the received intermediate output data into specialized output data and the output section produces output based on the resulting specialized output data.

Thus, once a driver for the first output device has been installed on an output request terminal such as a PC, relatively appropriate outputs can be provided using the first output device and second output device. Also, the need for the user to reconfigure output conditions can be reduced because the first output device transfers the intermediate output data obtained by conversion to another output device. This makes it possible to reduce the time and effort spent on installing drivers and save the user the trouble of making settings.

The “same type of devices” here means the type of devices which can handle specialized output data in the same format. This also applies to the output device selection system according to aspect 2, printer selection system according to aspect 3, output device according to aspects 10 and 11, network printer according to aspect 12, program for output device according to aspects 20 and 21, program for printer according to aspect 22, output device selection method according to aspects 30 and 31, and printer selection method according to aspect 32.

The output device selection section and the intermediate output data transfer section may be installed anywhere. For example, they may be installed on the first output device or a PC or other terminal. If they are installed on a PC or the like, according to a first configuration example, the first output device notifies the destination output device about the location of the intermediate output data of the specialized output data, and upon receiving the notification, the second output device acquires the intermediate output data from the PC. According to a second configuration example, the first output device sends a transfer request to a PC or the like, requesting it to transfer the intermediate output data of the specialized output data, and upon receiving the transfer request, the PC or the like transfers the intermediate output data to the destination output device.

Furthermore, aspect 2 is an output device selection system which communicably connects a plurality of output devices and selects one of the plurality of output devices to produce output, wherein:
a first output device from among the plurality of output devices comprises specialized output data receiving section for receiving specialized output data in an output format which can be output especially by devices of the same type as the first output device, data conversion section for converting the specialized output data received by the specialized output data receiving section into intermediate output data, output section for producing output based on the specialized output data received by the specialized output data receiving section, output device selection section for selecting a destination output device from among the plurality of output devices, and intermediate output data transfer section for transferring the intermediate output data produced by the data conversion section to the output device selected by the output device selection section; and
a second output device other than the first output device from among the plurality of output devices comprises intermediate output data receiving section for receiving the intermediate output data, inverse data conversion section for converting the intermediate output data received by the intermediate output data receiving section into specialized output data in an output format which can be output especially by devices of the same type as the second output device, and output section for producing output based on the specialized output data produced by the inverse data conversion section.

With this configuration, in order for an output request terminal such as a PC to request output from an output device, a driver for the first output device generates specialized output data in an output format which can be output especially by devices of the same type as the first output device and sends it to the first output device.

In the first output device, when the specialized output data receiving section receives the specialized output data, if, for example, the received specialized output data is to be output by another output device, the data conversion section converts the received specialized output data into intermediate output data. Then, the output device selection section selects a destination output device from among the plurality of output devices and the intermediate output data transfer section transfers the intermediate output data to the selected output device. On the other hand, for example, if the received specialized output data is to be output by the first output device, the output section produces output based on the received specialized output data.

In the second output device, when the intermediate output data receiving section receives the intermediate output data, the inverse data conversion section converts the received intermediate output data into specialized output data and the output section produces output based on the resulting specialized output data.

Thus, once a driver for the first output device has been installed on an output request terminal such as a PC, relatively appropriate outputs can be provided using the first output device and second output device. Also, the need for the user to reconfigure output conditions can be reduced because the first output device transfers the intermediate output data obtained by conversion to another output device. This makes it possible to reduce the time and effort spent on installing drivers and save the user the trouble of making settings.

On the other hand, to achieve the above object, aspect 3 is a printer selection system which communicably connects a plurality of network printers and selects one of the plurality of network printers in response to a print request from a print request terminal, wherein:
the network printer comprises specialized print data receiving section for receiving specialized print data in a print format which can be printed especially by devices of the same type as this network printer, data conversion section for converting the specialized print data received by the specialized print data receiving section into intermediate print data, network printer selection section for selecting a destination network printer from among the plurality of network printers, intermediate print data transfer section for transferring the intermediate print data produced by the data conversion section to the network printer selected by the network printer selection section, intermediate print data receiving section for receiving the intermediate print data, inverse data conversion section for converting the intermediate print data received by the intermediate print data receiving section into the specialized print data, and printing section for printing based on the specialized print data received by the specialized print data receiving section or the specialized print data produced by the inverse data conversion section; and
the data conversion section, the network printer selection section, and the intermediate print data transfer section operate based on predetermined printing conditions.

With this configuration, in order for a print request terminal such as a PC to do printing on a network printer, a printer driver for specific one of the network printers (hereinafter referred to as a specific network printer) generates specific print data in a print format which can be printed especially by devices of the same type as the specific network printer and sends it to the specific network printer.

On the specific network printer, when the specialized print data receiving section receives specialized print data, the data conversion section converts the received specialized print data into intermediate print data based on predetermined printing conditions (e.g., when the received specialized print data is to be printed by another network printer). Then, the network printer selection section selects a destination network printer from among the plurality of network printers and the intermediate print data transfer section transfers the intermediate print data to the selected network printer. On the other hand, for example, if the received specialized output data is to be printed on the specific network printer, the printing section does printing based on the received specialized print data.

On the other network printer, when the intermediate print data receiving section receives the intermediate print data, the inverse data conversion section converts the received intermediate print data into specialized print data and the printing section does printing based on the resulting specialized print data.

Thus, once a printer driver for a specific network printer has been installed on a print request terminal such as a PC, relatively appropriate outputs can be provided using a plurality of network printers. Also, the need for the user to reconfigure printing conditions can be reduced because the specific network printer transfers the intermediate output data obtained by conversion to another network printer. This makes it possible to reduce the time and effort spent on installing printer drivers and save the user the trouble of making settings.

Aspect 4 is the printer selection system according to aspect 3, wherein:
the specialized print data contains the printing conditions;
if the printing conditions contained in the specialized print data received by the specialized print data receiving section indicate that another one of the network printers should be used for printing, the data conversion section, the network printer selection section, and the intermediate print data transfer section operate based on the received printing conditions; and
if the printing conditions contained in the specialized print data received by the specialized print data receiving section indicate that the local network printer should be used for printing, the printing section does printing based on the received specialized print data.

With this configuration, in order for a print request terminal such as a PC to do printing on a desired network printer, printing conditions specifying the network printer to be used for printing are included in specialized print data and sent the specific network printer.

On the specific network printer, if the printing conditions contained in the received specialized print data indicate that another network printer should be used for printing, the data conversion section converts the received specialized print data into intermediate print data. Then, the network printer selection section selects a destination network printer from among the plurality of network printers and the intermediate print data transfer section transfers the intermediate print data to the selected network printer. On the other hand, if the printing conditions contained in the received specialized print data indicate that the local network printer should be used for printing, the printing section does printing based on the received specialized print data.

Thus, if the printing conditions contained in the received specialized print data indicate that another network printer should be used for printing, the intermediate print data is transferred to the other network printer. This makes it possible to print on a network printer which relatively satisfies user requirements.

Furthermore, aspect 5 is the printer selection system according to aspect 4, wherein:
if the printing conditions contained in the specialized print data received by the specialized print data receiving section indicate that another one of the network printers should be used for printing, the network printer selection section selects the network printer indicated by the printing conditions from among the plurality of network printers.

With this configuration, when specialized print data is received by a network printer, if the printing conditions contained in the received specialized print data indicate that another network printer should be used for printing, the network printer selection section selects the network printer indicated by the printing conditions from among the plurality of network printers.

Thus, the intermediate print data is transferred to the network printer indicated by the printing conditions. This makes it possible to print on a network printer which further satisfies user requirements.

Furthermore, aspect 6 is the printer selection system according to aspect 4, wherein:
the printer selection system maintains selection conditions for the network printer; and
the network printer selection section selects a destination network printer from among the plurality of network printers based on the selection conditions.

With this configuration, on a network printer, the network printer selection section selects a destination network printer from among the plurality of network printers based on the selection conditions.

Thus, the intermediate print data is transferred to the network printer indicated by the selection conditions. This makes it possible to print on a network printer which further satisfies user requirements.

Furthermore, aspect 7 is the printer selection system according to aspect 5 or 6, wherein:
the intermediate print data contains the printing conditions; and
if the printing conditions contained in the intermediate print data received by the intermediate print data receiving section indicate that the local network printer should be used for printing, the inverse data conversion section and the printing section operate based on the received intermediate print data.

With this configuration, when intermediate print data is received by a network printer, if the printing conditions contained in the received intermediate print data indicate that the local network printer should be used for printing, the inverse data conversion section converts the received intermediate print data into the specialized print data and the printing section does printing based on the resulting specialized print data.

Thus, if the printing conditions contained in the received specialized print data indicate that the local network printer should be used for printing, printing is done based on the specialized print data. This makes it possible to print on a network printer which further satisfies user requirements.

Furthermore, aspect 8 is the printer selection system according to any of aspects 3 to 7, wherein:
when transferring print data to the other network printer, the specialized print data is transferred as it is without conversion by the data conversion section if the destination network printer is of the same type as the local network printer.

With this configuration, when transferring print data to another network printer, the specialized print data is transferred as it is without conversion by the data conversion section if the destination network printer is of the same type as the local network printer.

Thus, in the case of transfer between network printers of the same type, there is no need for conversion between specialized print data and intermediate print data. This makes it possible to reduce processing time and do printing relatively quickly.

Aspect 9 is a printer selection system which communicably connects a plurality of network printers with a print request terminal and selects one of the plurality of network printers in response to a print request from the print request terminal, wherein:
the print request terminal comprises intermediate print data generating section for generating intermediate print data, and intermediate print data sending section for sending the intermediate print data generated by the intermediate print data generating section to one of the plurality of network printers;
the network printer comprises intermediate print data receiving section for receiving intermediate print data, intermediate print data transfer section for transferring the intermediate print data received by the intermediate print data receiving section to another network printer, inverse data conversion section for converting the intermediate print data received by the intermediate print data receiving section into specialized print data in a print format which can be printed especially by devices of the same type as this network printer, and printing section for printing based on the specialized print data produced by the inverse data conversion section; and
the intermediate print data transfer section operates based on predetermined printing conditions.

With this configuration, on the print request terminal, intermediate print data generating section generates intermediate print data and intermediate print data sending section sends the generated intermediate print data to a specific network printer.

In the specific network printer, when the intermediate print data receiving section receives intermediate print data, the intermediate print data transfer section transfers the received intermediate print data to another network printer based on predetermined printing conditions (e.g., when the received intermediate print data is to be printed by another network printer). On the other hand, when the received intermediate print data is to be printed on the specific network printer, the inverse data conversion section converts the received intermediate print data into the specialized print data, and the printing section does printing based on the resulting specialized print data.

Thus, once a printer driver for generating intermediate print data has been installed on a print request terminal such as a PC, relatively appropriate outputs can be provided using a plurality of network printers. Also, the need for the user to reconfigure printing conditions can be reduced because the intermediate print data is transferred to another network printer. This makes it possible to reduce the time and effort spent on installing printer drivers and save the user the trouble of making settings.

On the other hand, to achieve the above object, aspect 10 is an output device which communicably connects with a plurality of output devices, comprising:
specialized output data receiving section for receiving specialized output data in an output format which can be output especially by devices of the same type as this output device, data conversion section for converting the specialized output data received by the specialized output data receiving section into intermediate output data, output section for producing output based on the specialized output data received by the specialized output data receiving section, output device selection section for selecting a destination output device from among the plurality of output devices, and intermediate output data transfer section for transferring intermediate output data produced by the data conversion section to the output device selected by the output device selection section.

This configuration performs operation equivalent to that of the first output device in the output device selection system according to aspect 2, and thus offers effects equivalent to those of the output device selection system according to aspect 2.

Furthermore, aspect 11 is an output device which communicably connects with a plurality of output devices, comprising:
intermediate output data receiving section for receiving intermediate output data, inverse data conversion section for converting the intermediate output data received by the intermediate output data receiving section into specialized output data in an output format which can be output especially by devices of the same type as this output device, and output section for producing output based on the specialized output data produced by the inverse data conversion section.

This configuration performs operation equivalent to that of the second output device in the output device selection system according to aspect 2, and thus offers effects equivalent to those of the output device selection system according to aspect 2.

On the other hand, to achieve the above object, aspect 12 is a network printer which communicably connects with a plurality of network printers, wherein:
the network printer comprises specialized print data receiving section for receiving specialized print data in a print format which can be printed especially by devices of the same type as this network printer, data conversion section for converting the specialized print data received by the specialized print data receiving section into intermediate print data, network printer selection section for selecting a destination network printer from among the plurality of network printers, intermediate print data transfer section for transferring the intermediate print data produced by the data conversion section to the network printer selected by the network printer selection section, intermediate print data receiving section for receiving the intermediate print data, inverse data conversion section for converting the intermediate print data received by the intermediate print data receiving section into the specialized print data, and printing section for printing based on the specialized print data received by the specialized print data receiving section or the specialized print data produced by the inverse data conversion section; and
the data conversion section, the network printer selection section, and the intermediate print data transfer section operate based on predetermined printing conditions.

This configuration performs operation equivalent to that of the network printer in the output device selection system according to aspect 3, and thus offers effects equivalent to those of the output device selection system according to aspect 3.

Furthermore, aspect 13 is the network printer according to aspect 12, wherein:
the specialized print data contains the printing conditions;
if the printing conditions contained in the specialized print data received by the specialized print data receiving section indicate that another one of the network printers should be used for printing, the data conversion section, the network printer selection section, and the intermediate print data transfer section operate based on the received printing conditions; and
if the printing conditions contained in the specialized print data received by the specialized print data receiving section indicate that the local network printer should be used for printing, the printing section does printing based on the received specialized print data.

This configuration performs operation equivalent to that of the network printer in the output device selection system according to aspect 4, and thus offers effects equivalent to those of the output device selection system according to aspect 4.

Furthermore, aspect 14 is the network printer according to aspect 13, wherein:
if the printing conditions contained in the specialized print data received by the specialized print data receiving section indicate that another one of the network printers should be used for printing, the network printer selection section selects the network printer indicated by the printing conditions from among the plurality of network printers.

This configuration performs operation equivalent to that of the network printer in the output device selection system according to aspect 5, and thus offers effects equivalent to those of the output device selection system according to aspect 5.

Furthermore, aspect 15 is the network printer according to aspect 13, wherein:
the printer selection system maintains selection conditions for the network printer; and
the network printer selection section selects a destination network printer from among the plurality of network printers based on the selection conditions.

This configuration performs operation equivalent to that of the network printer in the output device selection system according to aspect 6, and thus offers effects equivalent to those of the output device selection system according to aspect 6.

Furthermore, aspect 16 is the network printer according to aspect 14 or 15, wherein:
the intermediate print data contains the printing conditions; and
if the printing conditions contained in the intermediate print data received by the intermediate print data receiving section indicate that the local network printer should be used for printing, the inverse data conversion section and the printing section operate based on the received intermediate print data.

This configuration performs operation equivalent to that of the network printer in the output device selection system according to aspect 7, and thus offers effects equivalent to those of the output device selection system according to aspect 7.

Furthermore, aspect 17 is the network printer according to any of aspects 12 to 16, wherein:
when transferring print data to the other network printer, the specialized print data is transferred as it is without conversion by the data conversion section if the destination network printer is of the same type as the local network printer.

This configuration performs operation equivalent to that of the network printer in the output device selection system according to aspect 8, and thus offers effects equivalent to those of the output device selection system according to aspect 8.

Furthermore, aspect 18 is a network printer which communicably connects with a plurality of network printers and a print request terminal which makes print requests to the network printer, comprising:
intermediate print data receiving section for receiving intermediate print data, intermediate print data transfer section for transferring the intermediate print data received by the intermediate print data receiving section to another network printer, inverse data conversion section for converting the intermediate print data received by the intermediate print data receiving section into specialized print data in a print format which can be printed especially by devices of the same type as this network printer, and printing section for printing based on the specialized print data produced by the inverse data conversion section,
wherein the intermediate print data transfer section operates based on predetermined printing conditions.

This configuration performs operation equivalent to that of the network printer in the output device selection system according to aspect 9, and thus offers effects equivalent to those of the output device selection system according to aspect 9.

On the other hand, to achieve the above object, aspect 19 is a print request terminal which communicably connects with a plurality of network printers, comprising:
intermediate print data generating section for generating intermediate print data, and intermediate print data sending section for sending the intermediate print data generated by the intermediate print data generating section to one of the plurality of network printers.

This configuration performs operation equivalent to that of the print request terminal in the output device selection system according to aspect 9, and thus offers effects equivalent to those of the output device selection system according to aspect 9.

On the other hand, to achieve the above object, aspect 20 is a program for output device to be executed by a computer which communicably connects with a plurality of output devices, wherein the program makes the computer execute processes to be implemented as:
specialized output data receiving section for receiving specialized output data in an output format which can be output especially by devices of the same type as this computer, data conversion section for converting the specialized output data received by the specialized output data receiving section into intermediate output data, output device selection section for selecting a destination output device from among the plurality of output devices, and intermediate output data transfer section for transferring intermediate output data produced by the data conversion section to the output device selected by the output device selection section.

When the program is read and executed by the computer, this configuration performs operation and offers effects equivalent to those of the output device according to aspect 10.

Furthermore, aspect 21 is a program for output device to be executed by a computer which communicably connects with a plurality of output devices, wherein the program makes the computer execute processes to be implemented as:
intermediate output data receiving section for receiving intermediate output data, inverse data conversion section for converting the intermediate output data received by the intermediate output data receiving section into specialized output data in an output format which can be output especially by devices of the same type as this computer.

When the program is read and executed by the computer, this configuration performs operation and offers effects equivalent to those of the output device according to aspect 11.

On the other hand, to achieve the above object, aspect 22 is a program for printer to be executed by a computer which communicably connects with a plurality of network printers, wherein the program makes the computer execute processes to be implemented as:
specialized print data receiving section for receiving specialized print data in a print format which can be printed especially by devices of the same type as this computer, data conversion section for converting the specialized print data received by the specialized print data receiving section into intermediate print data, network printer selection section for selecting a destination network printer from among the plurality of network printers, intermediate print data transfer section for transferring the intermediate print data produced by the data conversion section to the network printer selected by the network printer selection section, intermediate print data receiving section for receiving the intermediate print data, inverse data conversion section for converting the intermediate print data received by the intermediate print data receiving section into the specialized print data, and printing section for printing based on the specialized print data received by the specialized print data receiving section or the specialized print data produced by the inverse data conversion section; and
the data conversion section, the network printer selection section, and the intermediate print data transfer section operate based on predetermined printing conditions.

When the program is read and executed by the computer, this configuration performs operation and offers effects equivalent to those of the network printer according to aspect 12.

Furthermore, aspect 23 is the program for printer according to aspect 22, wherein:
the specialized print data contains the printing conditions;
if the printing conditions contained in the specialized print data received by the specialized print data receiving section indicate that another one of the network printers should be used for printing, the data conversion section, the network printer selection section, and the intermediate print data transfer section operate based on the received printing conditions; and
if the printing conditions contained in the specialized print data received by the specialized print data receiving section indicate that the local network printer should be used for printing, the printing section does printing based on the received specialized print data.

When the program is read and executed by the computer, this configuration performs operation and offers effects equivalent to those of the network printer according to aspect 13.

Furthermore, aspect 24 is the program for printer according to aspect 23, wherein:
if the printing conditions contained in the specialized print data received by the specialized print data receiving section indicate that another one of the network printers should be used for printing, the network printer selection section selects the network printer indicated by the printing conditions from among the plurality of network printers.

When the program is read and executed by the computer, this configuration performs operation and offers effects equivalent to those of the network printer according to aspect 14.

Furthermore, aspect 25 is the program for printer according to aspect 23, wherein:
the printer selection system maintains selection conditions for the network printer; and
the network printer selection section selects a destination network printer from among the plurality of network printers based on the selection conditions.

When the program is read and executed by the computer, this configuration performs operation and offers effects equivalent to those of the network printer according to aspect 15.

Furthermore, aspect 26 is the program for printer according to aspect 24 or 25, wherein:
the intermediate print data contains the printing conditions; and
if the printing conditions contained in the intermediate print data received by the intermediate print data receiving section indicate that the local network printer should be used for printing, the inverse data conversion section and the printing section operate based on the received intermediate print data.

When the program is read and executed by the computer, this configuration performs operation and offers effects equivalent to those of the network printer according to aspect 16.

Furthermore, aspect 27 is the program for printer according to any of aspects 22 to 26, wherein:
when transferring print data to the other network printer, the specialized print data is transferred as it is without conversion by the data conversion section if the destination network printer is of the same type as the local network printer.

When the program is read and executed by the computer, this configuration performs operation and offers effects equivalent to those of the network printer according to aspect 17.

Furthermore, aspect 28 is a program for printer to be executed by a computer which communicably connects with a plurality of network printers and a print request terminal which makes print requests to the network printer, wherein the program makes the computer execute processes to be implemented as:
intermediate print data receiving section for receiving intermediate print data, intermediate print data transfer section for transferring the intermediate print data received by the intermediate print data receiving section to another network printer, inverse data conversion section for converting the intermediate print data received by the intermediate print data receiving section into specialized print data in a print format which can be printed especially by devices of the same type as this network printer, and printing section for printing based on the specialized print data produced by the inverse data conversion section, and
the intermediate print data transfer section operates based on predetermined printing conditions.

When the program is read and executed by the computer, this configuration performs operation and offers effects equivalent to those of the network printer according to aspect 18.

On the other hand, to achieve the above object, aspect 29 is a program for terminal to be executed by a computer which communicably connects with a plurality of network printers, wherein the program makes the computer execute processes to be implemented as:
intermediate print data generating section for generating intermediate print data, and intermediate print data sending section for sending the intermediate print data generated by the intermediate print data generating section to one of the plurality of network printers.

When the program is read and executed by the computer, this configuration performs operation and offers effects equivalent to those of the print request terminal according to aspect 19.

On the other hand, to achieve the above object, aspect 30 is an output device selection method for communicably connecting a plurality of output devices and selecting one of the plurality of output devices to produce output, wherein:
for a first output device from among the plurality of output devices, the output device selection method comprises:
a specialized output data receiving step of receiving specialized output data in an output format which can be output especially by devices of the same type as the first output device, and
an output step of producing output based on the specialized output data received by the specialized output data receiving step;
the output device selection method further comprises:
an output device selection step of selecting a destination output device from among the plurality of output devices, and
an intermediate output data transfer step of transferring intermediate output data of the specialized output data to the output device selected by the output device selection step; and
for a second output device other than the first output device from among the plurality of output devices, the output device selection method comprises:
an intermediate output data receiving step of receiving the intermediate output data,
an inverse data conversion step of converting the intermediate output data received by the intermediate output data receiving step into specialized output data in an output format which can be output especially by devices of the same type as the second output device, and
an output step of producing output based on the specialized output data produced by the inverse data conversion step.

This offers effects equivalent to those of the output device selection system according to aspect 1.

Furthermore, aspect 31 is an output device selection method for communicably connecting a plurality of output devices and selecting one of the plurality of output devices to produce output, wherein:
for a first output device from among the plurality of output devices, the output device selection method comprises:
a specialized output data receiving step of receiving specialized output data in an output format which can be output especially by devices of the same type as the first output device,
a data conversion step of converting the specialized output data received by the specialized output data receiving step into intermediate output data if the specialized output data received by the specialized output data receiving step is to be output from another output device,
an output device selection step of selecting a destination output device from among the plurality of output devices,
an intermediate output data transfer step of transferring the intermediate output data produced by the data conversion step to the output device selected by the output device selection step, and
an output step of producing output based on the specialized output data received by the specialized output data receiving step if the specialized output data received by the specialized output data receiving step is to be output from the first output device; and
for a second output device other than the first output device from among the plurality of output devices, the output device selection method comprises:
an intermediate output data receiving step of receiving the intermediate output data,
an inverse data conversion step of converting the intermediate output data received by the intermediate output data receiving step into specialized output data in an output format which can be output especially by devices of the same type as the second output device, and
an output step of producing output based on the specialized output data produced by the inverse data conversion step.

This offers effects equivalent to those of the output device selection system according to aspect 2.

On the other hand, to achieve the above object, aspect 32 is a printer selection method for communicably connecting a plurality of network printers and selecting one of the plurality of network printers in response to a print request from a print request terminal, wherein:
for the network printer, the printer selection method comprises:
a specialized print data receiving step of receiving specialized print data in a print format which can be printed especially by devices of the same type as this network printer,
a data conversion step of converting the specialized print data received by the specialized print data receiving step into intermediate print data,
a network printer selection step of selecting a destination network printer from among the plurality of network printers,
an intermediate print data transfer step of transferring the intermediate print data produced by the data conversion step to the network printer selected by the network printer selection step,
an intermediate print data receiving step of receiving the intermediate print data,
an inverse data conversion step of converting the intermediate print data received by the intermediate print data receiving step into the specialized print data, and
a printing step of printing based on the specialized print data received by the specialized print data receiving step or the specialized print data produced by the inverse data conversion step; and
the data conversion step, the network printer selection step, and the intermediate print data transfer step are carried out based on predetermined printing conditions.

This offers effects equivalent to those of the printer selection system according to aspect 3.

Furthermore, aspect 33 is the printer selection method according to aspect 32, wherein:
the specialized print data contains the printing conditions;
if the printing conditions contained in the specialized print data received by the specialized print data receiving step indicate that another one of the network printers should be used for printing, the data conversion step, the network printer selection step, and the intermediate print data transfer step are carried out based on the received printing conditions; and
if the printing conditions contained in the specialized print data received by the specialized print data receiving step indicate that the local network printer should be used for printing, the printing step is carried out based on the received specialized print data.

This offers effects equivalent to those of the printer selection system according to aspect 4.

Furthermore, aspect 34 is the printer selection method according to aspect 33, wherein:
if the printing conditions contained in the specialized print data received by the specialized print data receiving step indicate that another one of the network printers should be used for printing, the network printer selection step selects the other network printer indicated by the printing conditions from among the plurality of network printers.

This offers effects equivalent to those of the printer selection system according to aspect 5.

Furthermore, aspect 35 is the printer selection method according to aspect 33, wherein:
the printer selection method maintains selection conditions for the network printer; and
the network printer selection step selects a destination network printer from among the plurality of network printers based on the selection conditions.

This offers effects equivalent to those of the printer selection system according to aspect 6.

Furthermore, aspect 36 is the printer selection method according to aspect 34 or 35, wherein:
the intermediate print data contains the printing conditions; and
if the printing conditions contained in the intermediate print data received by the intermediate print data receiving step indicate that the local network printer should be used for printing, the inverse data conversion step and the printing step are carried out based on the received intermediate print data.

This offers effects equivalent to those of the printer selection system according to aspect 7.

Furthermore, aspect 37 is the printer selection method according to any of aspects 32 to 36, wherein:
when transferring print data to the other network printer, the specialized print data is transferred as it is without carrying out the data conversion step if the destination network printer is of the same type as the local network printer.

This offers effects equivalent to those of the printer selection system according to aspect 8.

Furthermore, aspect 38 is a printer selection method for communicably connecting a plurality of network printers with a print request terminal and selecting one of the plurality of network printers in response to a print request from the print request terminal, wherein:
for the print request terminal, the printer selection method comprises:
   an intermediate print data generating step of generating intermediate print data, and
an intermediate print data sending step of sending the intermediate print data generated by the intermediate print data generating step to one of the plurality of network printers;
for the network printer, the printer selection method comprises:
an intermediate print data receiving step of receiving intermediate print data,
an intermediate print data transfer step of transferring the intermediate print data received by the intermediate print data receiving step to another network printer,
an inverse data conversion step of converting the intermediate print data received by the intermediate print data receiving step into specialized print data in a print format which can be printed especially by devices of the same type as this network printer, and
a printing step of printing based on the specialized print data produced by the inverse data conversion step; and
the intermediate print data transfer step operates based on predetermined printing conditions.

This offers effects equivalent to those of the printer selection system according to aspect 9.

### BRIEF DESCRIPTION OF THE DRAWINGS

FIG. 1 is a block diagram showing configuration of a network system to which the present invention is applied;

FIG. 2 is a block diagram showing configuration of a network printer 100;

FIG. 3 is a flowchart showing a printer selection process;

FIG. 4 is a diagram showing data structure of intermediate print data;

FIG. 5 is a diagram showing data structure of intermediate print data;

FIG. 6 is a block diagram showing configuration of a user terminal 200;

FIG. 7 is a flowchart showing a print request process;

FIG. 8 is a flowchart showing a printer selection process;

FIG. 9 is a flowchart showing a print request process;

FIG. 10 is a functional block diagram showing configuration of the network printer 100 and user terminal 200;

FIG. 11 is a flowchart showing a print request process;

FIG. 12 is a diagram showing data structure of intermediate print data;

FIG. 13 is a diagram showing data structure of intermediate print data;

FIG. 14 is a flowchart showing an intermediate print data providing process;

FIG. 15 is a flowchart showing a printer selection process;

FIG. 16 is a diagram showing data structure of a print data request;

FIG. 17 is a functional block diagram showing configuration of the network printer 100 and user terminal 200; and

FIG. 18 is a flowchart showing a printer selection process.

### DETAILED DESCRIPTION OF THE PREFERRED EMBODIMENTS

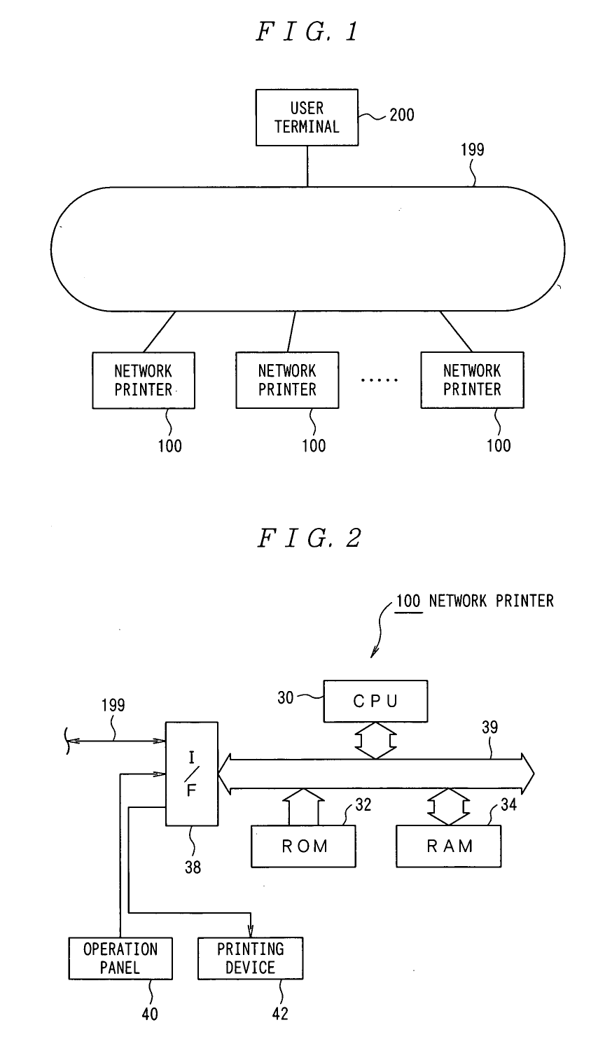

A first embodiment of the present invention will be described below with reference to drawings. FIGS. 1 to 7 are diagrams showing embodiments of an output device selection system, printer selection system, output device, program for output device, and output device selection method according to the present invention.

In this embodiment, the output device selection system, printer selection system, output device, program for output device, and output device selection method according to the present invention are applied to a case in which a printer used for printing is selected from among a plurality of network printers 100 in response to a print request from a user terminal 200 as shown in FIG. 1.

First, configuration of a network system to which the present invention is applied will be described with reference to FIG. 1.

FIG. 1 is a block diagram showing the configuration of the network system to which the present invention is applied.

The Internet 199 is connected with the network printers 100 and the user terminal 200 which makes print requests to network printers 100 as shown in FIG. 1. Incidentally, although only one user terminal 200 is shown in the figure to facilitate understanding, actually a large number of user terminals 200 are connected to the Internet 199.

Next, configuration of the network printer 100 will be described with reference to FIG. 2.

FIG. 2 is a block diagram showing the configuration of the network printer 100.

As shown in FIG. 2, the network printer 100 comprises a CPU 30 which performs operations and controls the entire system based on a control program, ROM 32 for prestoring the control program of the CPU 30 in a predetermined area, RAM 34 for storing data read out of the ROM 32 and necessary results of CPU 30 operations, and an I/F 38 which mediates input and output of data from/to external equipment, all of which are interconnected via a bus 39—which is a signal line for data transfer—to allow data exchange among them.

The I/F 38 is connected with external devices: an operation panel 40 serving as a human interface which allows data to be entered, printer which prints based on print data, and signal line for connecting to the Internet 199.

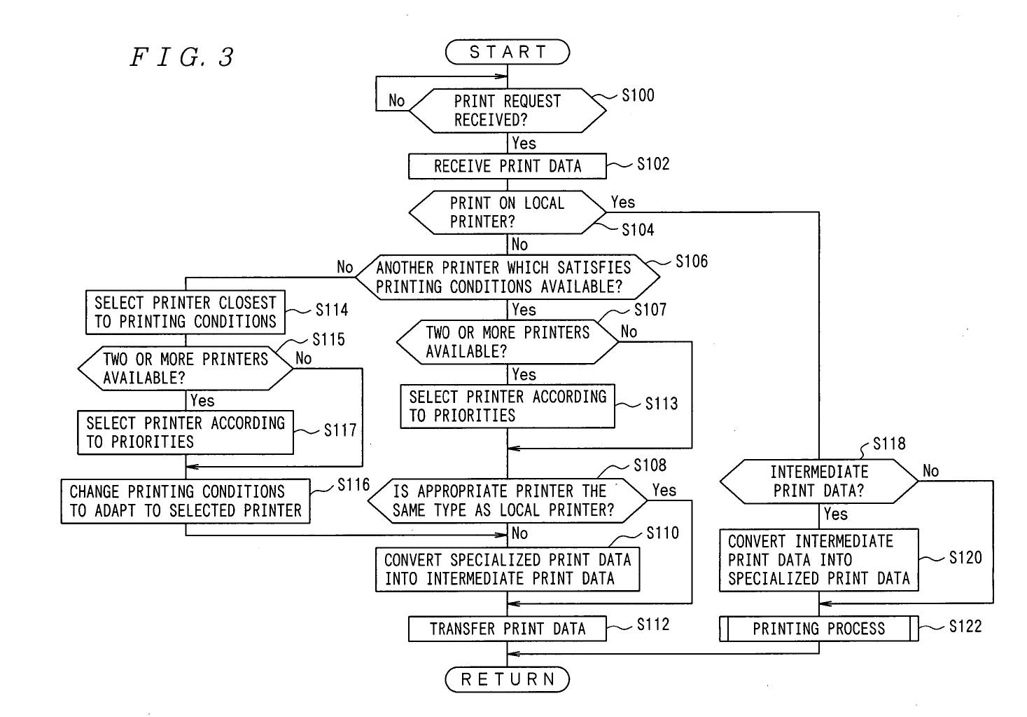

The CPU 30 consists of a microprocessing unit (MPU), etc. It starts a predetermined program stored in a predetermined area of the ROM 32 and performs a printer selection process shown in a flowchart of FIG. 3 according to the program.

FIG. 3 is the flowchart showing the printer selection process.

The printer selection process involves selecting a printer to be used for printing from among the network printers 100 in response to a print request from a user terminal 200. The process is performed by the CPU 30, beginning with Step S100 as shown in FIG. 3.

In Step S100, the CPU 30 judges whether a print request has been received. If it is found that a print request has been received (Yes), the CPU 30 goes to Step S102. Otherwise, the CPU 30 waits at Step S100 until a print request is received.

In Step S102, print data is received. Print data is roughly divided into specialized print data in a print format which can be printed especially by devices of the same type as this network printer 100 and intermediate print data in a print format which can be handled commonly by all the network printers 100.

The specialized print data is print data in a format handled by conventional printers and varies with the printers. The same type of devices means devices which can handle specialized print data in the same format.

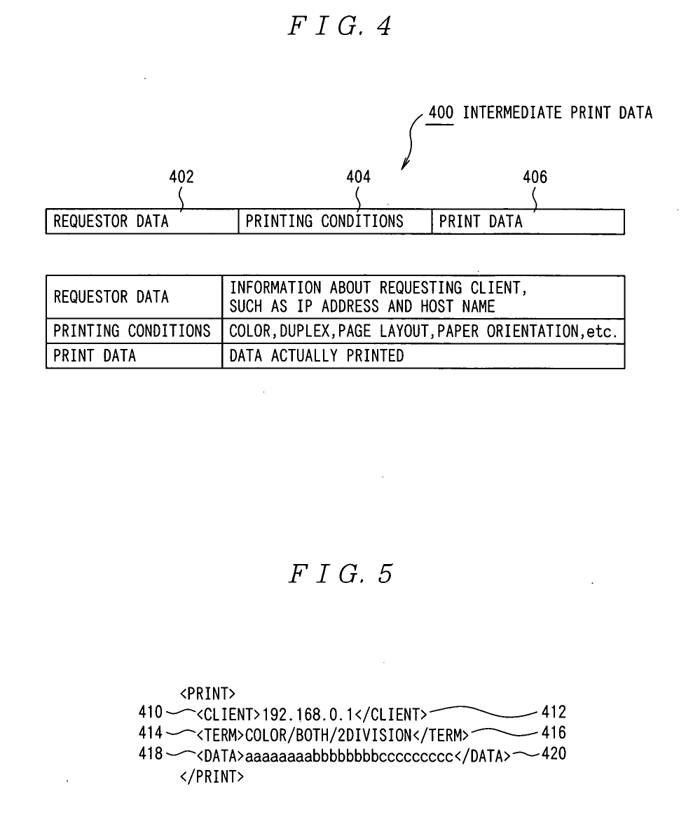

The intermediate print data has the data structure shown in FIGS. 4 and 5.

FIGS. 4 and 5 are diagrams showing the data structure of the intermediate print data.

As shown in FIG. 4, the intermediate print data 400 comprises a data area 402 for storing requestor data including the network address of the requesting user terminal 200, data area 404 for storing printing conditions, and data area 406 for storing print data to be printed. The printing conditions include, for example, the network address of the network printer 100 desired to be used for printing, the number of copies, whether to collate pages, whether to print sets of the same pages (111, 222, 333) or sets of successive pages (123, 123, 123), print pages, paper size, paper orientation, a sheet feeder (selection of a paper tray), a paper type (selection of plain paper, OHP film, or the like), print quality (fast or high quality), a paper ejector, scaling (enlarge/reduce), page layout (2 pages/sheet, 4 pages/sheet, etc.), a stamp (Secret, Confidential, etc.), backward printing, duplex printing & stitching position, stapling & stitching position, form overlay (printing on standard-size paper), a page header, and a banner page (cover page which indicates who the printed material belongs).

Specifically, as shown in FIG. 5, the intermediate print data 400 starts with a predetermined start tag (e.g., <PRINT>) and ends with a predetermined end tag (e.g., </PRINT>). It describes requestor data, printing conditions, and print data, each of which is sandwiched by a tag set consisting of a start tag and end tag. The example in FIG. 5 describes requestor data sandwiched by a tag set 410 and 412, printing conditions sandwiched by a tag set 414 and 416, and print data sandwiched by a tag set 418 and 420. The tag set 410 and 412 encloses “192.168.0.1,” the tag set 414 and 416 encloses “COLOR/BOTH/2DIVISION,” and the tag set 418 and 420 encloses “aaaaaaaabbbbbbbbccccccccc.” This means that the network address of the requesting user terminal 200 is “192.168.0.1” and that color printing, duplex printing, and double-column format are specified as printing conditions.

Returning to FIG. 3, when print data (hereinafter, specialized print data and intermediate print data will be referred to collectively as print data) is received in Step S102, the CPU 30 goes to Step S104, where it judges whether the printing conditions contained in the received print data indicate that the printing should be done on the local network printer 100. If it is found that the printing will not be done on the local network printer 100 (No), the CPU 30 goes to Step S106.

In Step S106, the CPU 30 judges whether another network printer 100 which satisfies the printing conditions contained in the received print data is available on the Internet 199. If it is found that another network printer 100 which satisfies the printing conditions is available on the Internet 199 (Yes), the CPU 30 goes to Step S107.

In Step S107, the CPU 30 judges whether there are two or more network printers 100 which satisfy the printing conditions. If it is found that there is only one network printer 100 (No), the CPU 30 goes to Step S108, where it judges whether the network printer 100 is of the same type as the local network printer 100. If it is found that the network printer 100 is not the same type (No), the CPU 30 goes to Step S110.

In Step S110, if the received print data is specialized print data, the CPU 30 converts it into intermediate print data, and then goes to Step S112. In Step S112, the CPU 30 transfers the converted or received print data to the other network printer 100 indicated by the printing conditions, and then finishes the sequence of processes and returns to the original process.

On the other hand, if it is found in Step S108 that the network printer 100 is of the same type as the local network printer 100 (Yes), the CPU 30 goes to Step S112.

On the other hand, if it is found in Step S107 that there are two or more network printers 100 which satisfy the printing conditions (Yes), the CPU 30 goes to Step S113, where it selects one of the network printers 100 in accordance with certain priorities, and then it goes to Step S108.

On the other hand, if it is found in Step S106 that no network printer 100 which satisfies the printing conditions contained in the received print data is available on the Internet 199 (No), the CPU 30 goes to Step S114, where it selects a network printer 100 which satisfies the printing conditions closest to the printing conditions contained in the received print data from among the network printers 100, and then it goes to Step S115.

In Step S115, the CPU 30 judges whether there are two or more network printers 100 which satisfy the printing conditions closest to the specified printing conditions. If it is found that there is only one network printer 100 (No), the CPU 30 goes to Step S116, where it changes the printing conditions contained in the received print data to adapt to the selected network printer 100, and then it goes to Step S110.

On the other hand, if it is found in Step S115 that there are two or more network printers 100 which satisfy the printing conditions closest to the specified printing conditions (Yes), the CPU 30 goes to Step S117, where it selects one of the network printers 100 in accordance with certain priorities, and then it goes to Step S116.

On the other hand, if it is found in Step S104 that the printing conditions contained in the received print data indicate that the printing should be done on the local network printer 100 (Yes), the CPU 30 goes to Step S118, where it judges whether the received print data is intermediate print data. If it is found that it is intermediate print data (Yes), the CPU 30 goes to Step S120.

In Step S120, the CPU 30 converts the received intermediate print data into specialized print data. Then, the CPU 30 goes to Step S122, where it performs a printing process on a printing device 42 based on the converted or received specialized print data. Then, the CPU 30 finishes the sequence of processes and returns to the original process.

On the other hand, if it is found in Step S118 that the received print data is not intermediate print data (No), the CPU 30 goes to Step S122.

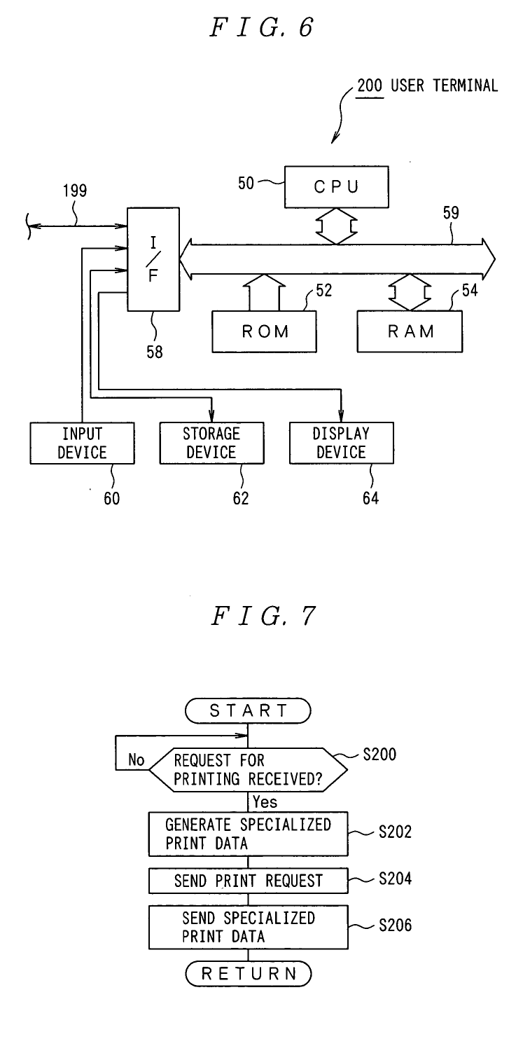

Next, configuration of the user terminal 200 will be described in detail with reference to FIG. 6.

FIG. 6 is a block diagram showing the configuration of the user terminal 200.

As shown in FIG. 6, the user terminal 200 comprises a CPU 50 which performs operations and controls the entire system based on a control program, ROM 52 for prestoring the control program of the CPU 50 in a predetermined area, RAM 54 for storing data read out of the ROM 52 and necessary results of CPU 50 operations, and an I/F 58 which mediates input and output of data from/to external equipment, all of which are interconnected via a bus 59—which is a signal line for data transfer—to allow data exchange among them.

The I/F 58 is connected with external devices: an input device 60 consisting of human interfaces such as a keyboard, mouse, etc. which allow data to be entered, storage device 62 which stores data, tables, etc. as files, display device 64 which displays screens based on image signals, and signal line for connecting to the Internet 199.

The CPU 50 consists of a microprocessing unit (MPU), etc. It starts a predetermined program stored in a predetermined area of the ROM 52 and performs a print request process shown in a flowchart of FIG. 7 according to the program.

FIG. 7 is the flowchart showing the print request process.

The print request process is implemented as a printer driver for one of a plurality of network printers 100 (hereinafter referred to as a specific network printer 100). The process is performed by the CPU 50, beginning with Step S200 as shown in FIG. 7.

In Step S200, the CPU 50 judges whether a request for printing has been entered via the input device 60. If it is judged that a request for printing has been entered (Yes), the CPU 50 goes to Step S202. Otherwise, the CPU 50 waits at Step S200 until a request for printing is entered.

In Step S202, the CPU 50 generates specialized print data for the specific network printer 100. Then, the CPU 50 sends a print request to the specific network printer 100 in Step S204 and sends the generated specialized print data to the specific network printer 100 in Step S206. Then, the CPU 50 finishes the sequence of processes and returns to the original process.

Next, operation of this embodiment will be described.

To do printing on a network printer 100, the user enters printing conditions and a request for printing in the user terminal 200 via the input device 60. Incidentally, only a printer driver for a specific network printer 100 has been installed on the user terminal 200.

When the printing conditions and request for printing are entered in the user terminal 200, the CPU 50 goes through Step S202 to generate specialized print data for the specific network printer 100. The specialized print data contains the entered printing conditions. Then, the CPU 50 goes through Steps S204 and S206 to send a print request and the generated specialized print data to the specific network printer 100.

When the specific network printer 100 receives the print request and specialized print data, the CPU 30 goes through Step S104 to judge whether the printing conditions contained in the received specialized print data indicate that the printing should be done on the local network printer 100. If it is found that the printing will not be done on the local network printer 100, the CPU 30 goes through Step S106 to judge whether a network printer 100 which satisfies the printing conditions is available on the Internet 199. If it is found that an appropriate network printer 100 is available on the Internet 199, the CPU 30 goes through Step S108 to judge whether the appropriate network printer 100 is of the same type as the specific network printer 100. If it is found that the appropriate network printer 100 is a different type, the CPU 30 goes through Steps S110 and S112 to convert the received specialized print data into intermediate print data and send the resulting intermediate print data to the appropriate network printer 100.

When the appropriate network printer 100 receives the intermediate print data, since the intermediate print data is to be printed on the network printer 100 itself, the CPU 30 goes through Steps S118 to S122 to convert the received intermediate print data into specialized print data and do printing based on the resulting specialized print data.

On the specific network printer 100, if it is found in Step S108 that the appropriate network printer 100 is of the same type as the specific network printer 100, the CPU 30 goes through Step S112 to send the received specialized print data as it is to the appropriate network printer 100.

When the appropriate network printer 100 receives the specialized print data, since the specialized print data is to be printed on the network printer 100 itself, the CPU 30 goes through Steps S118 and S122 to do printing based on the received specialized print data.

On the specific network printer 100, if it is found in Step S106 that no network printer 100 which satisfies the printing conditions is available on the Internet 199, the CPU 30 goes through Steps S114 and S116 to select a network printer 100 which satisfies the printing conditions closest to the printing conditions contained in the received specialized print data from among the network printers 100 and change the printing conditions contained in the received specialized print data to adapt to the selected network printer 100. Then, the CPU 30 goes through Steps S110 and S112 to convert the received specialized print data into intermediate print data and send the resulting intermediate print data to the selected network printer 100.

When the selected network printer 100 receives the intermediate print data, since the intermediate print data is to be printed on the selected network printer 100 itself, the CPU 30 goes through Steps S118 to S122 to convert the received intermediate print data into specialized print data and do printing based on the resulting specialized print data.

On the specific network printer 100, if it is found in Step S104 that the printing conditions contained in the received specialized print data indicate that the printing should be done on the local network printer 100, the CPU 30 goes through Steps S118 and S122 to do printing based on the received specialized print data.

In this way, according to this embodiment, if a network printer 100 receives specialized print data which contains printing conditions indicating that printing should be done on another network printer 100, it converts the received specialized print data into intermediate print data and transfers the resulting intermediate print data to the other network printer 100. On the other hand, if the network printer 100 receives specialized print data which contains printing conditions indicating that printing should be done on the network printer 100 itself, it does printing based on the received specialized print data. However, if it receives intermediate print data, it converts the received intermediate print data into specialized print data and does printing based on the resulting specialized print data.

Thus, once a printer driver for a specific network printer 100 has been installed on the user terminal 200, printing can be done relatively appropriately using a plurality of network printers 100. Also, the need for the user to reconfigure printing conditions can be reduced because the specific network printer 100 transfers the intermediate print data obtained by conversion to another network printer 100. This makes it possible to reduce the time and effort spent on installing printer drivers and save the user the trouble of making settings.

Also, if the printing conditions contained in the received specialized print data indicate that another network printer 100 should be used for printing, the intermediate print data is transferred to the other network printer 100. This makes it possible to print on a network printer 100 which relatively satisfies user requirements.

Also, since the specialized print data which can be processed in the same format is not converted and only the data that must be processed in a different format is converted into intermediate print data, the number of conversions can be decreased, reducing the processing load of the entire system.

Furthermore, according to this embodiment, if a network printer 100 receives specialized print data which contains printing conditions indicating that printing should be done on another network printer 100, it transfers the intermediate print data obtained by conversion to the other network printer 100 indicated by the printing conditions.

Since the intermediate print data is transferred to the other network printer 100 indicated by the printing conditions, it is possible to print on a network printer 100 which further satisfies user requirements.

Furthermore, according to this embodiment, if a network printer 100 receives intermediate print data which contains printing conditions indicating that printing should be done on the network printer 100 itself, it converts the received intermediate print data into specialized print data and does printing based on the resulting specialized print data.

Thus, if the printing conditions contained in the received intermediate print data indicate that the local network printer should be used for printing, printing is done based on the specialized print data. This makes it possible to print on a network printer 100 which further satisfies user requirements.

Furthermore, according to this embodiment, when transferring print data, if the destination network printer 100 is of the same type as the source network printer 100, specialized print data is transferred as it is without conversion into intermediate print data.

Thus, in the case of transfer between network printers of the same type, there is no need for conversion between specialized print data and intermediate print data. This makes it possible to reduce processing time and do printing relatively quickly.

In the first embodiment described above, the network printer 100 corresponds to the output device according to aspects 1, 2, 10, 11, 20, and 21 while the printing device 42 corresponds to the output device according to aspects 1, 2, 10, and 11, and the printing section according to aspects 3, 4, 7, 12, 13, 16, 22, 23, and 26. Also, Step S102 corresponds to the specialized output data receiving section according to aspects 1, 2, 10, and 20, the specialized print data receiving section according to any of aspects 3 to 5, 12 to 14, 22 to 24, the intermediate output data receiving section according to aspects 1, 2, 11, and 21, and the intermediate print data receiving section according to aspects 3, 7, 12, 16, 22, and 26.

Also, in the first embodiment described above, Step S110 corresponds to the data conversion section according to any of aspects 2 to 4, 8, 10, 12, 13, 17, 20, 23, and 27 while Step S112 corresponds to the intermediate output data transfer section according to aspects 1, 2, 10, and 20, and intermediate print data transfer section according to aspects 3, 4, 12, 13, 22, and 23. Also, Step S120 corresponds to the inverse data conversion section according to any of aspects 1 to 3, 7, 11, 12, 16, 21, 22, and 26; the user terminal 200 corresponds to the print request terminal according to aspect 3; and the specialized print data corresponds to the specialized output data according to aspects 1, 2, 10, 11, 20, and 21.

Also, in the first embodiment described above, the intermediate print data corresponds to the intermediate output data according to aspects 1, 2, 10, 11, 20, and 21.

In the first embodiment described above, the network printer 100 corresponds to the output device according to aspects 30 and 31, the printing device 42 corresponds to the output step according to aspects 30 and 31, and Step S102 corresponds to the intermediate output data receiving step according to aspects 30 and 31. Also, Step S110 corresponds to the data conversion step according to any of aspects 31 to 33 and 37, Step S112 corresponds to the intermediate output data transfer step according to aspects 30 and 31, and Step S120 corresponds to the inverse data conversion step according to any of aspects 30 to 32 and 36.

Also, in the first embodiment described above, the user terminal 200 corresponds to the print request terminal according to aspect 32, specialized print data corresponds to the specialized output data according to aspects 30 and 31, and the intermediate print data corresponds to the intermediate output data according to aspects 30 and 31.

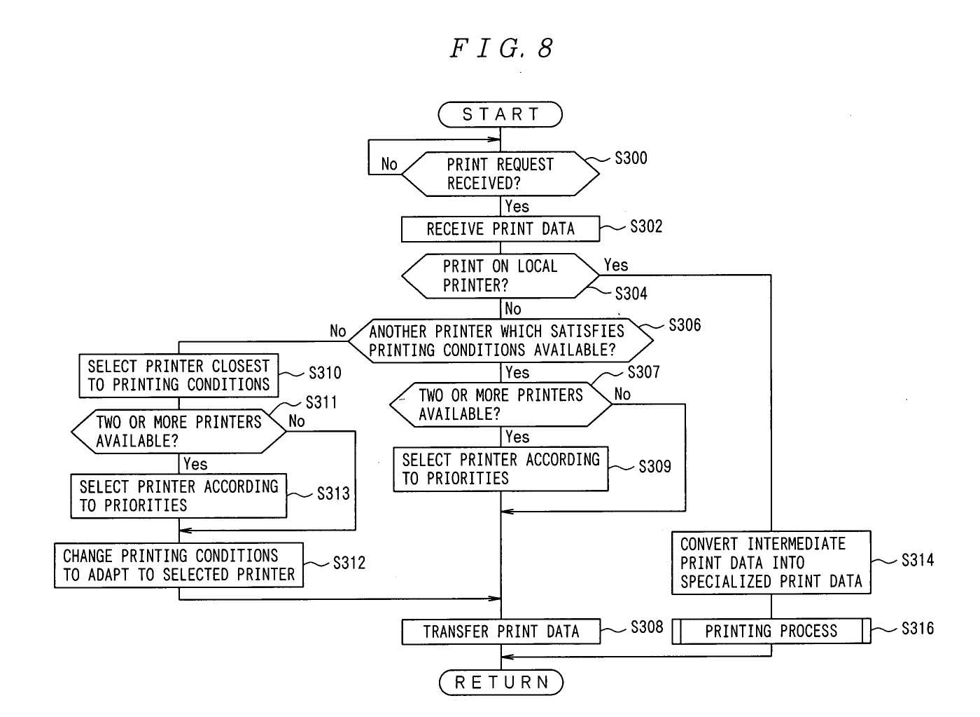

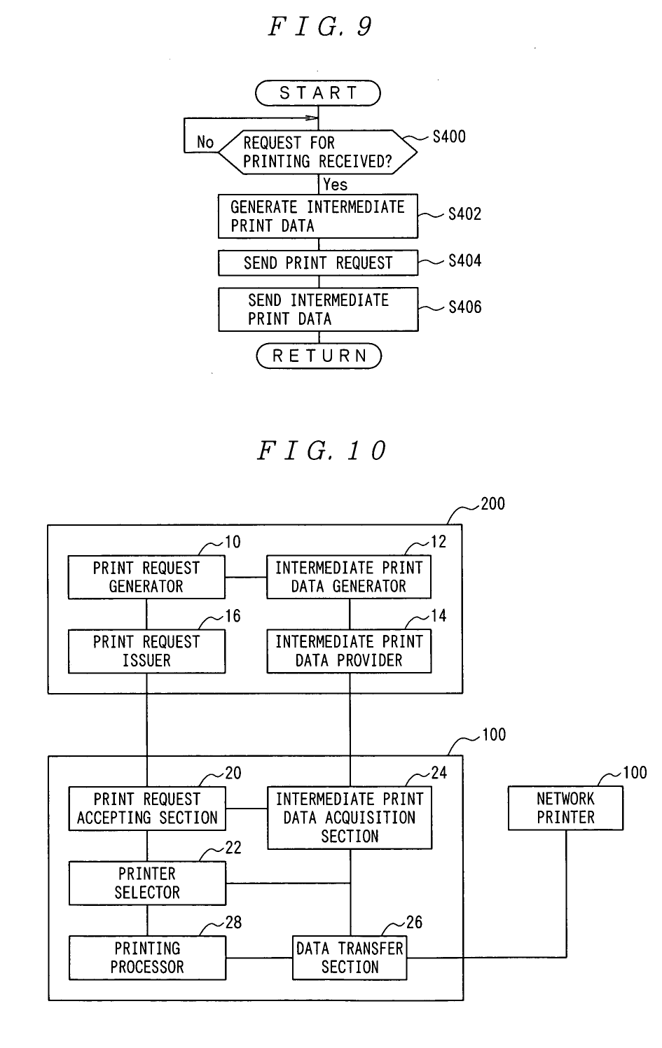

Next, a second embodiment of the present invention will be described with reference to drawings. FIGS. 8 and 9 are diagrams showing embodiments of an output device selection system, printer selection system, output device, program for output device, and output device selection method according to the present invention. Incidentally, only those parts which differ from the first embodiment will be described below. The same components as the first embodiment will be denoted by the same reference numerals as the corresponding components of the first embodiment, and description thereof will be omitted.

In this embodiment, the output device selection system, printer selection system, output device, program for output device, and output device selection method according to the present invention are applied to a case in which a printer used for printing is selected from among a plurality of network printers 100 in response to a print request from a user terminal 200 as shown in FIG. 1. This embodiment differs from the first embodiment in that intermediate print data is generated by the user terminal 200.

Next, the configuration of the network printer 100 will be described in detail.

The CPU 30 starts a predetermined program stored in a predetermined area of the ROM 32 and performs a printer selection process shown in a flowchart of FIG. 8 instead of the printer selection process shown in the flowchart of FIG. 3.

FIG. 8 is the flowchart showing the printer selection process.

The printer selection process is performed by the CPU 30, beginning with Step S300 as shown in FIG. 8.

In Step S300, the CPU 30 judges whether a print request has been received. If it is judged that a print request has been received (Yes), the CPU 30 goes to Step S302. Otherwise, the CPU 30 waits at Step S300 until a print request is received.

In Step S302, the CPU 30 receives intermediate print data. Then, it goes to Step S304, where it judges whether the printing conditions contained in the received intermediate print data indicate that the printing should be done on the local network printer 100. If it is found that the printing will not be done on the local network printer 100 (No), the CPU 30 goes to Step S306.

In Step S306, the CPU 30 judges whether another network printer 100 which satisfies the printing conditions contained in the received intermediate print data is available on the Internet 199. If it is found that another network printer 100 which satisfies the printing conditions is available on the Internet 199 (Yes), the CPU 30 goes to Step S307.

In Step S307, the CPU 30 judges whether there are two or more network printers 100 which satisfy the printing conditions. If it is found that there is only one network printer 100 (No), the CPU 30 goes to Step S308, where it transfers the received intermediate print data to the other network printer 100 indicated by the printing conditions. Then, the CPU 30 finishes the sequence of processes and returns to the original process.

On the other hand, if it is found in Step S307 that there are two or more network printers 100 which satisfy the printing conditions (Yes), the CPU 30 goes to Step S309, where it selects one of the network printers 100 in accordance with certain priorities, and then it goes to Step S308. Specifically, in Step S309, a network printer is selected according to: (1) priorities assigned to the network printers 100 by the user in advance, (2) priorities assigned to the printing conditions (e.g., descending order of print quality, ascending order of printing cost, etc.) by the user in advance, or (3) the order in which network printers are detected automatically. This similarly applies to Steps S313, S113, and S117.

On the other hand, if it is found in Step S306 that no network printer 100 which satisfies the printing conditions contained in the received intermediate print data is available on the Internet 199 (No), the CPU 30 goes to Step S310, where it selects a network printer 100 which satisfies the printing conditions closest to the printing conditions contained in the received intermediate print data from among the network printers 100, and then it goes to Step S311.

In Step S311, the CPU 30 judges whether there are two or more network printers 100 which satisfy the printing conditions closest to the specified printing conditions. If it is found that there is only one network printer 100 (No), the CPU 30 goes to Step S312, where it changes the printing conditions contained in the received intermediate print data to adapt to the selected network printer 100, and then it goes to Step S308.

On the other hand, if it is found in Step S311 that there are two or more network printers 100 which satisfy the printing conditions closest to the specified printing conditions (Yes), the CPU 30 goes to Step S313, where it selects one of the network printers 100 in accordance with certain priorities, and then it goes to Step S308.

On the other hand, if it is found in Step S304 that the printing conditions contained in the received intermediate print data indicate that the printing should be done on the local network printer 100 (Yes), the CPU 30 goes to Step S314, where it converts the received intermediate print data into specialized print data. Then, the CPU 30 performs a printing process to do printing based on the resulting specialized print data in Step S316, finishes the sequence of processes, and returns to the original process.

Next, the configuration of the user terminal 200 will be described in detail.

The CPU 50 starts a predetermined program stored in a predetermined area of the ROM 52 and performs a print request process shown in a flowchart of FIG. 9 instead of the print request process shown in the flowchart of FIG. 7.

FIG. 9 is the flowchart showing the print request process.

The print request process is performed by the CPU 50, beginning with Step S400 as shown in FIG. 9.

In Step S400, the CPU 50 judges whether a request for printing has been entered via the input device 60. If it is judged that a request for printing has been entered (Yes), the CPU 50 goes to Step S402. Otherwise, the CPU 50 waits at Step S400 until a request for printing is entered.

In Step S402, the CPU 50 generates intermediate print data. Then, the CPU 50 sends a print request to the specific network printer 100 in Step S404 and sends the generated intermediate print data to the specific network printer 100 in Step S406. Then, the CPU 50 finishes the sequence of processes and returns to the original process.

Next, operation of this embodiment will be described.

To do printing on a network printer 100, the user enters printing conditions and a request for printing in the user terminal 200 via the input device 60. Incidentally, only a printer driver for a specific network printer 100 has been installed on the user terminal 200.

When the printing conditions and request for printing are entered in the user terminal 200, the CPU 50 goes through Step S402 to generate intermediate print data. The intermediate print data contains the entered printing conditions. Then, the CPU 50 goes through Steps S404 and S406 to send a print request and the generated intermediate print data to the specific network printer 100.

When the specific network printer 100 receives the print request and intermediate print data, the CPU 30 goes through Step S304 to judge whether the printing conditions contained in the received intermediate print data indicate that the printing should be done on the local network printer 100. If it is found that the printing will not be done on the local network printer 100, the CPU 30 goes through Step S306 to judge whether a network printer 100 which satisfies the printing conditions is available on the Internet 199. If it is found that an appropriate network printer 100 is available on the Internet 199, the CPU 30 goes through Step S308 to send the received intermediate print data to the appropriate network printer 100.

When the appropriate network printer 100 receives the intermediate print data, since the intermediate print data is to be printed on the network printer 100 itself, the CPU 30 goes through Steps S314 and S316 to convert the received intermediate print data into specialized print data and do printing based on the resulting specialized print data.

On the specific network printer 100, if it is found in Step S306 that no network printer 100 which satisfies the printing conditions is available on the Internet 199, the CPU 30 goes through Steps S310 and S312 to select a network printer 100 which satisfies the printing conditions closest to the printing conditions contained in the received intermediate print data from among the network printers 100 and change the printing conditions contained in the received intermediate print data to adapt to the selected network printer 100. Then, the CPU 30 goes through Step S318 to convert the received intermediate print data to the selected network printer 100.

When the selected network printer 100 receives the intermediate print data, since the intermediate print data is to be printed on the selected network printer 100 itself, the CPU 30 goes through Steps S314 and S316 to convert the received intermediate print data into specialized print data and do printing based on the resulting specialized print data.

On the specific network printer 100, if it is found in Step S304 that the printing conditions contained in the received intermediate print data indicate that the printing should be done on the local network printer 100, the CPU 30 goes through Steps S314 and S316 to convert the received intermediate print data into specialized print data and do printing based on the resulting specialized print data.

In this way, according to this embodiment, if a network printer 100 receives intermediate print data which contains printing conditions indicating that printing should be done on another network printer 100, it transfers the received intermediate print data to the other network printer 100. On the other hand, if a network printer 100 receives intermediate print data which contains printing conditions indicating that printing should be done on the network printer 100 itself, it converts the received intermediate print data into specialized print data and does printing based on the resulting specialized print data.

Thus, once a printer driver for generating intermediate print data has been installed on the user terminal 200, printing can be done relatively appropriately using a plurality of network printers 100. Also, the need for the user to reconfigure printing conditions can be reduced because intermediate print data is transferred to another network printer 100. This makes it possible to reduce the time and effort spent on installing printer drivers and save the user the trouble of making settings.

In the second embodiment described above, the printing device 42 corresponds to the printing section according to aspects 9, 18, and 28; the printing on the printing device 42 corresponds to the printing step according to aspect 38; Step S302 corresponds to the intermediate print data receiving section according to aspects 9, 18, and 28, and intermediate print data receiving step according to aspect 38. Also, Step S308 corresponds to the intermediate print data transfer section according to aspects 9, 18, and 28, and intermediate print data transfer step according to aspect 38; and Step S314 corresponds to the inverse data conversion section according to aspects 9, 18, and 28, and inverse data conversion step according to aspect 38.

Also, in the second embodiment described above, the user terminal 200 corresponds to the print request terminal according to aspects 9, 18, 28, and 38; Step S402 corresponds to the intermediate print data generating section according to aspect 9 and intermediate print data generating step according to aspect 38; and Step S406 corresponds to the intermediate print data sending section according to aspect 9 and intermediate print data sending step according to aspect 38.

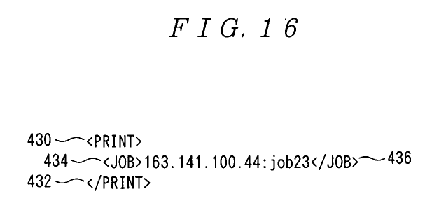

Next, a third embodiment of the present invention will be described with reference to drawings. FIGS. 10 and 16 are diagrams showing embodiments of an output device selection system, printer selection system, output device, program for output device, and output device selection method according to the present invention. Incidentally, only those parts which differ from the first embodiment will be described below. The same components as the first embodiment will be denoted by the same reference numerals as the corresponding components of the first embodiment, and description thereof will be omitted.

In this embodiment, the output device selection system, printer selection system, output device, program for output device, and output device selection method according to the present invention are applied to a case in which a printer used for printing is selected from among a plurality of network printers 100 in response to a print request from a user terminal 200 as shown in FIG. 10. This embodiment differs from the first embodiment in that the network printer 100 acquires intermediate print data from the user terminal 200.

First, functions of the network printer 100 and user terminal 200 will be outlined with reference to FIG. 10.

FIG. 10 is a functional block diagram showing configuration of the network printer 100 and user terminal 200.

As shown in FIG. 10, the user terminal 200 comprises a print request generator 10 which generates a print request and print data, intermediate print data generator 12 which generates intermediate print data based on the print data generated by the print request generator 10, intermediate print data provider 14 which provides the intermediate print data generated by the intermediate print data generator 12 to the network printer 100, and print request issuer 16 which issues the print request and print data generated by the print request generator 10 to the network printer 100.

The print request issuer 16 puts an identifier of the print data generated by the print request generator 10 in a print request as a printing condition and sends the print request together with specialized print data to the specific network printer 100.

When the intermediate print data provider 14 receives a print data request containing an identifier, it searches for intermediate print data based on the identifier contained in the print data request and provides the retrieved intermediate print data to the requesting network printer 100.

As shown in FIG. 10, the network printer 100 comprises a print request accepting section 20 which accepts print data together with a print request, printer selector 22 which selects a destination network printer 100 from among network printers 100, intermediate print data acquisition section 24 which acquires intermediate print data from the user terminal 200, data transfer section 26 which transfers the intermediate print data acquired by the intermediate print data acquisition section 24 together with the print request to the destination network printer 100, and printing processor 28 which performs a printing process based on the specialized print data accepted by the print request accepting section 20.

If the printing conditions contained in the print data received by the print request accepting section 20 indicate that printing will not be done on the local network printer 100, the printer selector 22 selects the network printer 100 which satisfies the specified printing conditions or the printing conditions closest to the specified printing conditions as the destination network printer 100.

If the printing conditions contained in the print data indicate that printing will not be done on the local network printer 100, the intermediate print data acquisition section 24 puts the identifier contained in the printing conditions in a print data request, sends the print data request to the user terminal 200, and thereby acquires intermediate print data.

If the printing conditions contained in the print data indicate that printing should be done on the local network printer 100 and that the print data is intermediate print data, the printing processor 28 converts the intermediate print data accepted by the print request accepting section 20 into specialized print data and does printing based on the resulting specialized print data. If the printing conditions contained in the print data indicate that printing should be done on the local network printer 100 and that the print data is specialized print data, printing is done based on the specialized print data accepted by the print request accepting section 20.

Next, the configuration of the user terminal 200 will be described in detail.

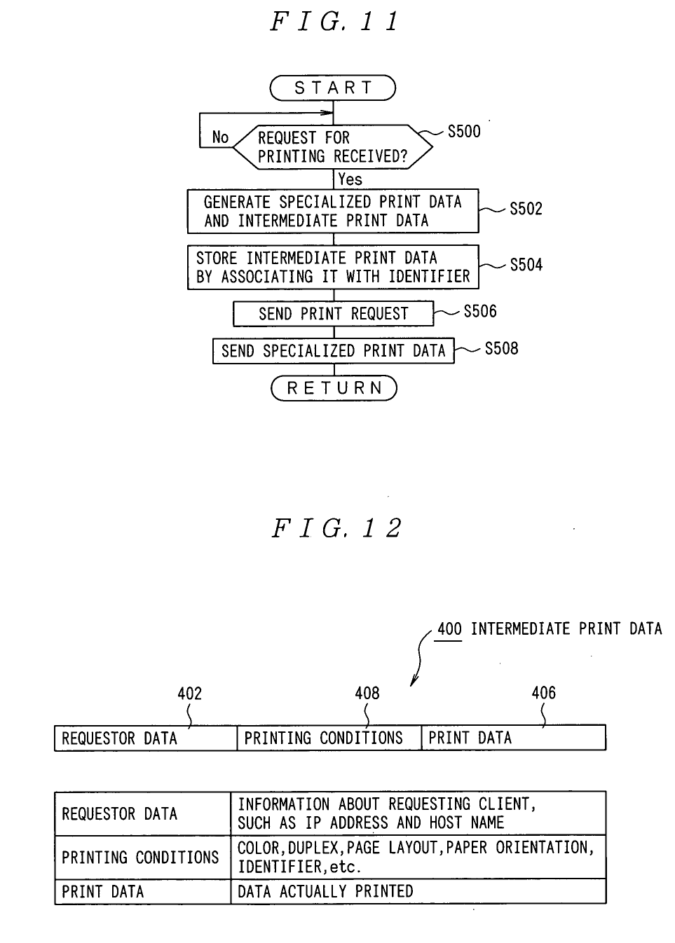

The CPU 50 starts a predetermined program stored in a predetermined area of the ROM 52 and performs a print request process and intermediate print data providing process shown in flowcharts of FIGS. 11 and 14 on a time-shared basis instead of the print request process shown in the flowchart of FIG. 7.

First, the print request process will be described in detail with reference to FIG. 11.

FIG. 11 is the flowchart showing the print request process.

The print request process is implemented as the intermediate print data generator 12 and print request issuer 16. It is performed by the CPU 50, beginning with Step S500 as shown in FIG. 11.

In Step S500, the CPU 50 judges whether a request for printing has been entered via the input device 60. If it is judged that a request for printing has been entered (Yes), the CPU 50 goes to Step S502. Otherwise, the CPU 50 waits at Step S500 until a request for printing is entered.

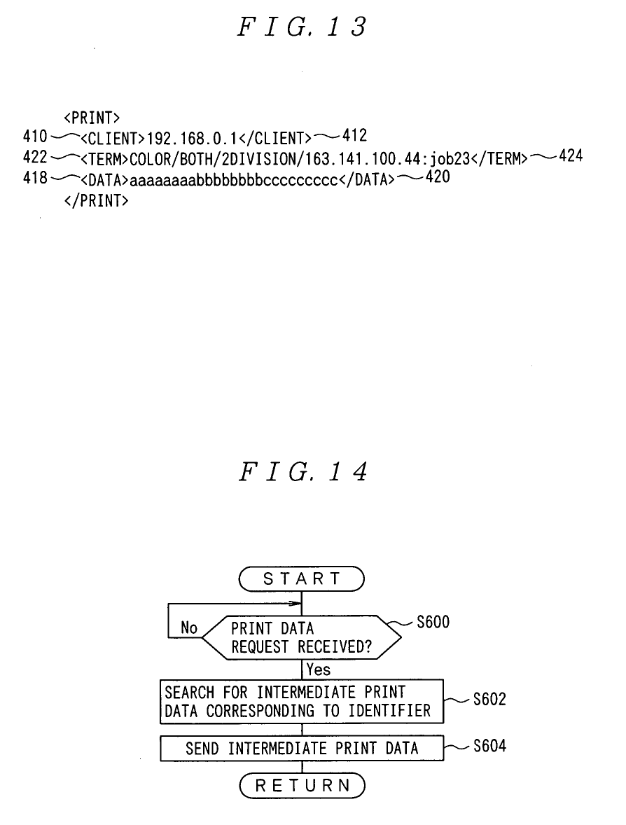

In Step S502, the CPU 50 generates specialized print data for the specific network printer 100 and its intermediate print data. Then, in Step S504, the CPU 50 stores the generated intermediate print data in the storage device 62 by associating it with an identifier. The intermediate print data has the data structure shown in FIGS. 12 and 13.

FIGS. 12 and 13 are diagrams showing the data structure of the intermediate print data.

As shown in FIG. 12, the intermediate print data 400 comprises a data area 402 for storing requestor data including the network address of the requesting user terminal 200, data area 408 for storing printing conditions, and data area 406 for storing print data to be printed. The printing conditions include, for example, the identifier of the intermediate print data in addition to the printing conditions listed in relation to the first embodiment.

Specifically, as shown in FIG. 13, the intermediate print data 400 starts with a predetermined start tag (e.g., <PRINT>) and ends with a predetermined end tag (e.g., </PRINT>). It describes requester data, printing conditions, and print data, each of which is sandwiched by a tag set consisting of a start tag and end tag. The example in FIG. 13 describes requestor data sandwiched by a tag set 410 and 412, printing conditions sandwiched by a tag set 422 and 424, and print data sandwiched by a tag set 418 and 420. The tag set 410 and 412 encloses “192.168.0.1,” the tag set 422 and 424 encloses “COLOR/BOTH/2DIVISION/163.141.100.44:job23,” and the tag set 418 and 420 encloses “aaaaaaaabbbbbbbbccccccccc.” This means that the network address of the requesting user terminal 200 is “192.168.0.1” and that color printing, duplex printing, double-column format, and the identifier of intermediate print data (acquisition source address) specified as printing conditions.

Returning to FIG. 11, the CPU 50 stores the intermediate print data in Step S504 and sends a print request to the specific network printer 100 in Step S506 by including the identifier of the generated intermediate print data in the print request as a printing condition. Then, the CPU 50 sends generated specialized print data to the specific network printer 100 in Step S508, finishes the sequence of processes, and returns to the original process.

Next, the intermediate print data providing process will be described in detail with reference to FIG. 14.

FIG. 14 is a flowchart showing the intermediate print data providing process.

The intermediate print data providing process is implemented as the intermediate print data provider 14. It is performed by the CPU 50, beginning with Step S600 as shown in FIG. 14.

In Step S600, the CPU 50 judges whether a print data request has been received. If it is judged that a print data request has been received (Yes), the CPU 50 goes to Step S602. Otherwise, the CPU 50 waits at Step S600 until a print data request is received.

In Step S602, the CPU 50 searches the storage device 62 for the appropriate intermediate print data based on the identifier contained in the print data request, and then goes to Step S604, where it provides the retrieved intermediate print data to the requesting network printer 100. Then, the CPU 50 finishes the sequence of processes and returns to the original process.

Next, the configuration of the network printer 100 will be described in detail.

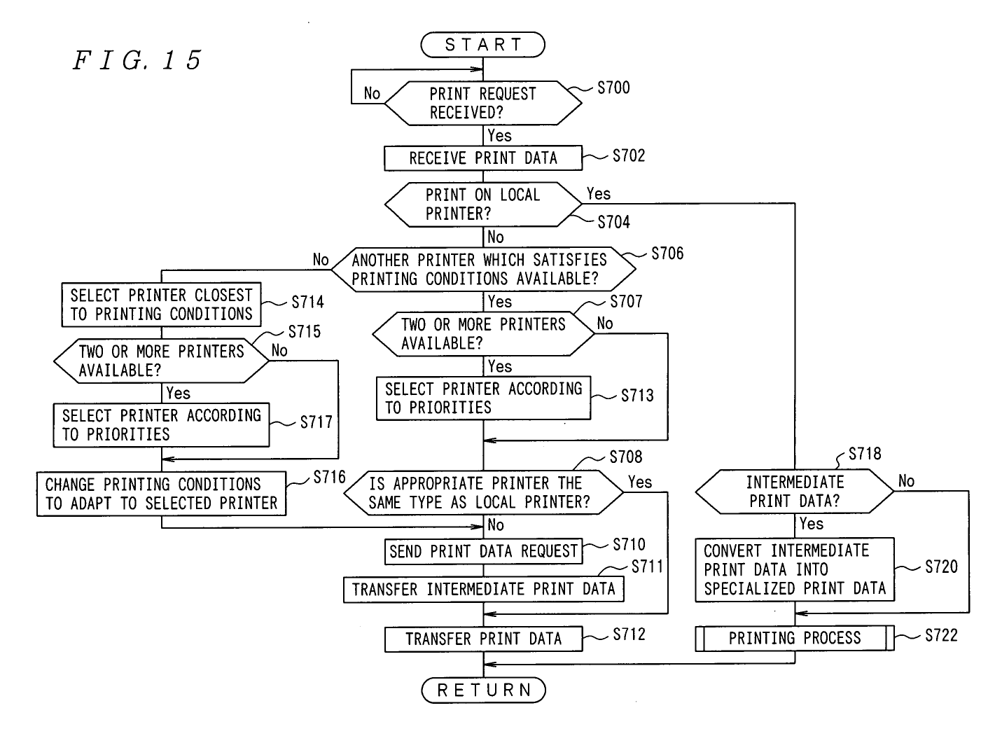

The CPU 30 starts a predetermined program stored in a predetermined area of the ROM 32 and performs a printer selection process shown in a flowchart of FIG. 15 instead of the printer selection process shown in the flowchart of FIG. 3.

FIG. 15 is the flowchart showing the printer selection process.

The printer selection process is implemented as the print request accepting section 20, printer selector 22, intermediate print data acquisition section 24, data transfer section 26, and printing processor 28. It is performed by the CPU 30, beginning with Step S700 as shown in FIG. 15.

In Step S700, the CPU 30 judges whether a print request has been received. If it is judged that a print request has been received (Yes), the CPU 30 goes to Step S702. Otherwise, the CPU 30 waits at Step S700 until a print request is received.

In Step S702, the CPU 30 receives print data. Then, it goes to Step S704, where it judges whether the printing conditions contained in the print data indicate that the printing should be done on the local network printer 100. If it is found that the printing will not be done on the local network printer 100 (No), the CPU 30 goes to Step S706.

In Step S706, the CPU 30 judges whether another network printer 100 which satisfies the printing conditions contained in the received print data is available on the Internet 199. If it is found that another network printer 100 which satisfies the printing conditions is available on the Internet 199 (Yes), the CPU 30 goes to Step S707.

In Step S707, the CPU 30 judges whether there are two or more network printers 100 which satisfy the printing conditions. If it is found that there is only one network printer 100 (No), the CPU 30 goes to Step S708, where it judges whether the appropriate network printer 100 is of the same type as the local network printer 100. If it is found that the appropriate network printer 100 is not the same type (No), the CPU 30 goes to Step S710.

In Step S710, the CPU 30 puts the identifier contained in the printing conditions in a print data request and sends the print data request to the user terminal 200. The print data request has the data structure shown in FIG. 16.

FIG. 16 is a diagram showing the data structure of the print data request.

As shown in FIG. 16, the intermediate print data 400 starts with a predetermined start tag (e.g., <PRINT>) and ends with a predetermined end tag (e.g., </PRINT>). It describes the identifier sandwiched by a tag set consisting of a start tag and end tag. The example in FIG. 16 describes the identifier sandwiched by a tag set 434 and 436. The tag set 434 and 436 encloses “163.141.100.44:job23.” This means that the identifier is “163.141.100.44:job23.”

Returning to FIG. 15, the CPU 30 sends the print data request in Step S710, receives intermediate print data in Step S711, and transfers the received print data to the network printer 100 indicated by the printing conditions in Step S712. Then, the CPU 30 finishes the sequence of processes and returns to the original process.

On the other hand, if it is found in Step S708 that the appropriate network printer 100 is of the same type as the local network printer 100 (Yes), the CPU 30 goes to Step S712.

On the other hand, if it is found in Step S707 that there are two or more network printers 100 which satisfy the printing conditions (Yes), the CPU 30 goes to Step S713, where it selects one of the network printers 100 in accordance with certain priorities, and then it goes to Step S708.

On the other hand, if it is found in Step S706 that no network printer 100 which satisfies the printing conditions contained in the received print data is available on the Internet 199 (No), the CPU 30 goes to Step S714, where it selects a network printer 100 which satisfies the printing conditions closest to the printing conditions contained in the received print data from among the network printers 100, and then it goes to Step S715.

In Step S715, the CPU 30 judges whether there are two or more network printers 100 which satisfy the printing conditions closest to the specified printing conditions. If it is found that there is only one network printer 100 (No), the CPU 30 goes to Step S716, where it changes the printing conditions contained in the received print data to adapt to the selected network printer 100, and then it goes to Step S710.

On the other hand, if it is found in Step S715 that there are two or more network printers 100 which satisfy the printing conditions closest to the specified printing conditions (Yes), the CPU 30 goes to Step S717, where it selects one of the network printers 100 in accordance with certain priorities, and then it goes to Step S716.

On the other hand, if it is found in Step S704 that the printing conditions contained in the received print data indicate that the printing should be done on the local network printer 100 (Yes), the CPU 30 goes to Step S718, where it judges whether the received print data is intermediate print data. If it is found that it is intermediate print data (Yes), the CPU 30 goes to Step S720.

In Step S720, the CPU 30 converts the received intermediate print data into specialized print data. Then, the CPU 30 goes to Step S722, where it performs a printing process on a printing device 42 based on the converted or received specialized print data. Then, the CPU 30 finishes the sequence of processes and returns to the original process.

On the other hand, if it is found in Step S718 that the received print data is not intermediate print data (No), the CPU 30 goes to Step S722.

Next, operation of this embodiment will be described.

To do printing on a network printer 100, the user enters printing conditions and a request for printing in the user terminal 200 via the input device 60.

When the printing conditions and request for printing are entered in the user terminal 200, the CPU 50 goes through Steps S502 and S504 to generate specialized print data for the specific network printer 100 and its intermediate print data and store the generated intermediate print data by associating it with an identifier. Then, the CPU 50 goes through Steps S506 and S508 to send the print request and generated specialized print data to the specific network printer 100.

When the specific network printer 100 receives the print request and specialized print data, the CPU 30 goes through Step S704 to judge whether the printing conditions contained in the received specialized print data indicate that the printing should be done on the local network printer 100. If it is found that the printing will not be done on the local network printer 100, the CPU 30 goes through Step S706 to judge whether a network printer 100 which satisfies the printing conditions is available on the Internet 199. If it is found that an appropriate network printer 100 is available on the Internet 199, the CPU 30 goes through Step S708 to judge whether the appropriate network printer 100 is of the same type as the specific network printer 100. If it is found that the appropriate network printer 100 is a different type, the CPU 30 goes through Step S710 to send the print data request containing the identifier to the user terminal 200.

When the user terminal 200 receives the print data request, the CPU 50 goes through Steps S602 and S604 to search for the appropriate intermediate print data based on the identifier contained in the print data request and send the retrieved intermediate print data to the specific network printer 100.

When the specific network printer 100 receives the intermediate print data, the CPU 30 goes through Steps S711 and S712 to send the retrieved intermediate print data to the appropriate network printer 100.

When the appropriate network printer 100 receives the intermediate print data, since the intermediate print data is to be printed on the network printer 100 itself, the CPU 30 goes through Steps S718 to S722 to convert the received intermediate print data into specialized print data and do printing based on the resulting specialized print data.

In this way, according to this embodiment, if a network printer 100 receives specialized print data which contains printing conditions indicating that printing should be done on another network printer 100, it receive intermediate print data corresponding to the received specialized print data from the user terminal 200 and transfers the received intermediate print data to the other network printer 100. On the other hand, if the network printer 100 receives specialized print data which contains printing conditions indicating that printing should be done on the network printer 100 itself, it does printing based on the received specialized print data. However, if it receives intermediate print data, it converts the received intermediate print data into specialized print data and does printing based on the resulting specialized print data.

Thus, once a printer driver for a specific network printer 100 has been installed on the user terminal 200, printing can be done relatively appropriately using a plurality of network printers 100. Also, the need for the user to reconfigure printing conditions can be reduced because the specific network printer 100 transfers the intermediate print data obtained by conversion to another network printer 100. This makes it possible to reduce the time and effort spent on installing printer drivers and save the user the trouble of making settings.

Also, if the printing conditions contained in the received specialized print data indicate that another network printer should be used for printing, the intermediate print data is transferred to the other network printer. This makes it possible to print on a network printer which relatively satisfies user requirements.

Also, since the specialized print data which can be processed in the same format is not converted and only the data that must be processed in a different format is converted into intermediate print data, the number of conversions can be decreased, reducing the processing load of the entire system.

In the third embodiment described above, the network printer 100 corresponds to the output device according to aspects 1 and 30; the printing device 42 corresponds to the output section according to aspect 1; and Step S702 corresponds to the specialized output data receiving section according to aspect 1, specialized output data receiving step according to aspect 30, intermediate output data receiving section according to aspect 1, and intermediate output data receiving step according to aspect 30. Also, Step S712 corresponds to the intermediate output data transfer section according to aspect 1 and intermediate output data transfer step according to aspect 30, Step S720 corresponds to the inverse data conversion section according to aspect 1 and inverse data conversion step according to aspect 30, and the specialized print data corresponds to the specialized output data according to aspects 1 and 30.

Also, in the third embodiment described above, the intermediate print data corresponds to the intermediate output data according to aspects 1 and 30.

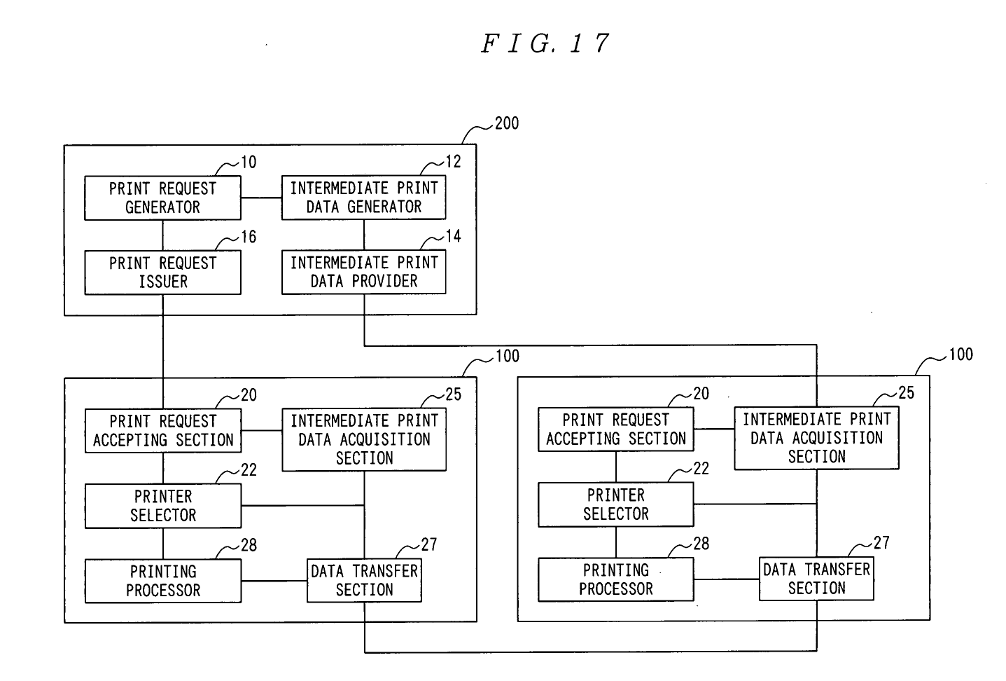

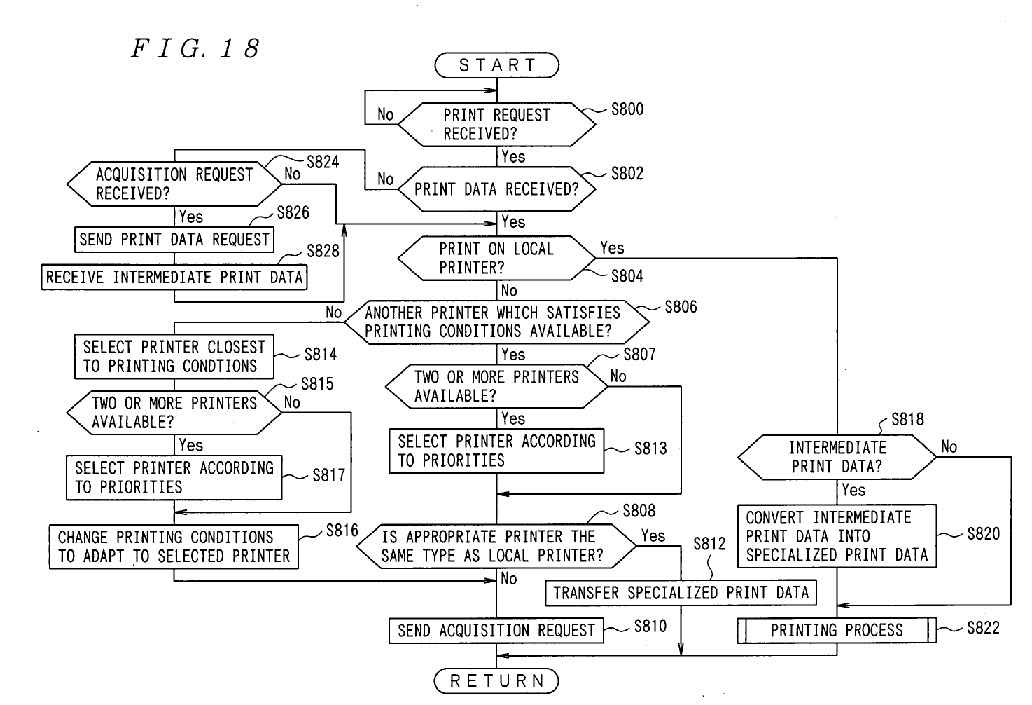

Next, a fourth embodiment of the present invention will be described with reference to drawings. FIGS. 17 and 18 are diagrams showing embodiments of an output device selection system, printer selection system, output device, program for output device, and output device selection method according to the present invention. Incidentally, only those parts which differ from the first embodiment will be described below. The same components as the third embodiment will be denoted by the same reference numerals as the corresponding components of the third embodiment, and description thereof will be omitted.

In this embodiment, the output device selection system, printer selection system, output device, program for output device, and output device selection method according to the present invention are applied to a case in which a printer used for printing is selected from among a plurality of network printers 100 in response to a print request from a user terminal 200 as shown in FIG. 17. This embodiment differs from the third embodiment in that the destination network printer 100 acquires intermediate print data from the user terminal 200.

First, functions of the network printer 100 and user terminal 200 will be outlined with reference to FIG. 17.

FIG. 17 is a functional block diagram showing configuration of the network printer 100 and user terminal 200.

As shown in FIG. 17, the user terminal 200 comprises a print request generator 10, intermediate print data generator 12, intermediate print data provider 14, and print request issuer 16.

As shown in FIG. 17, the network printer 100 comprises a print request accepting section 20, printer selector 22, printing processor 28, data transfer section 27 which transfers a print data request containing the identifier of the intermediate print data to the destination network printer 100, and intermediate print data acquisition section 25 which sends the print data request containing the identifier and accepted by the print request accepting section 20 to the user terminal 200 and acquires the intermediate print data.

Next, the configuration of the network printer 100 will be described in detail.

The CPU 30 starts a predetermined program stored in a predetermined area of the ROM 32 and performs a printer selection process shown in a flowchart of FIG. 18 instead of the printer selection process shown in the flowchart of FIG. 15.

FIG. 18 is the flowchart showing the printer selection process.

The printer selection process is implemented as the print request accepting section 20, printer selector 22, intermediate print data acquisition section 25, data transfer section 27, and printing processor 28. It is performed by the CPU 30, beginning with Step S800 as shown in FIG. 18.

In Step S800, the CPU 30 judges whether a print request has been received. If it is judged that a print request has been received (Yes), the CPU 30 goes to Step S802. Otherwise, the CPU 30 waits at Step S800 until a print request is received.

In Step S802, the CPU 30 judges whether print data has been received. If it is judged that print data has been received (Yes), the CPU 30 goes to Step S804, where it judges whether the printing conditions contained in the print data indicate that the printing should be done on the local network printer 100. If it is found that the printing will not be done on the local network printer 100 (No), the CPU 30 goes to Step S806.

In Step S806, the CPU 30 judges whether another network printer 100 which satisfies the printing conditions contained in the received print data is available on the Internet 199. If it is found that another network printer 100 which satisfies the printing conditions is available on the Internet 199 (Yes), the CPU 30 goes to Step S807.

In Step S807, the CPU 30 judges whether there are two or more network printers 100 which satisfy the printing conditions. If it is found that there is only one network printer 100 (No), the CPU 30 goes to Step S808, where it judges whether the appropriate network printer 100 is of the same type as the local network printer 100. If it is found that the appropriate network printer 100 is not the same type (No), the CPU 30 goes to Step S810.

In Step S810, the CPU 30 puts the identifier contained in the printing conditions in an acquisition request and sends the acquisition request to the other network printer 100. The acquisition request has a data structure similar to that of the print data request (FIG. 16).

After sending the acquisition request in Step S810, the CPU 30 finishes the sequence of processes and returns to the original process.

On the other hand, if it is found in Step S808 that the appropriate network printer 100 is of the same type as the local network printer 100 (Yes), the CPU 30 goes to Step S812, where it transfers received specialized print data to the other network printer 100 indicated by the printing conditions. Then, the CPU 30 finishes the sequence of processes and returns to the original process.

On the other hand, if it is found in Step S807 that there are two or more network printers 100 which satisfy the printing conditions (Yes), the CPU 30 goes to Step S813, where it selects one of the network printers 100 in accordance with certain priorities, and then it goes to Step S808.

On the other hand, if it is found in Step S806 that no network printer 100 which satisfies the printing conditions contained in the received print data is available on the Internet 199 (No), the CPU 30 goes to Step S814, where it selects a network printer 100 which satisfies the printing conditions closest to the printing conditions contained in the received print data from among the network printers 100, and then it goes to Step S815.

In Step S815, the CPU 30 judges whether there are two or more network printers 100 which satisfy the printing conditions closest to the specified printing conditions. If it is found that there is only one network printer 100 (No), the CPU 30 goes to Step S816, where it changes the printing conditions contained in the received print data to adapt to the selected network printer 100, and then it goes to Step S810.

On the other hand, if it is found in Step S815 that there are two or more network printers 100 which satisfy the printing conditions closest to the specified printing conditions (Yes), the CPU 30 goes to Step S817, where it selects one of the network printers 100 in accordance with certain priorities, and then it goes to Step S816.

On the other hand, if it is found in Step S804 that the printing conditions contained in the received print data indicate that the printing should be done on the local network printer 100 (Yes), the CPU 30 goes to Step S818, where it judges whether the received print data is intermediate print data. If it is found that it is intermediate print data (Yes), the CPU 30 goes to Step S820.

In Step S820, the CPU 30 converts the received intermediate print data into specialized print data. Then, the CPU 30 goes to Step S822, where it performs a printing process on a printing device 42 based on the converted or received specialized print data. Then, the CPU 30 finishes the sequence of processes and returns to the original process.

On the other hand, if it is found in Step S818 that the received print data is not intermediate print data (No), the CPU 30 goes to Step S822.

On the other hand, if it is found in Step S802 that no print data has been received (No), the CPU 30 goes to Step S824, where it judges whether an acquisition request has been received. If it is found that an acquisition request has been received (Yes), the CPU 30 goes to Step S826.

In Step S826, the CPU 30 puts the identifier contained in the acquisition request in a print data request and sends the print data request to the user terminal 200. Then, the CPU 30 receives intermediate print data in Step S828 and goes to Step S804.

On the other hand, if it is found in Step S824 that no acquisition request has been received (No), the CPU 30 goes to Step S804.

Next, operation of this embodiment will be described.

To do printing on a network printer 100, the user enters printing conditions and a request for printing in the user terminal 200 via the input device 60.

When the printing conditions and request for printing are entered in the user terminal 200, the CPU 50 goes through Steps S502 and S504 to generate specialized print data for the specific network printer 100 and its intermediate print data and store the generated intermediate print data by associating it with an identifier. Then, the CPU 50 goes through Steps S506 and S508 to send the print request and generated specialized print data to the specific network printer 100.

When the specific network printer 100 receives the print request and specialized print data, the CPU 30 goes through Step S804 to judge whether the printing conditions contained in the received specialized print data indicate that the printing should be done on the local network printer 100. If it is found that the printing will not be done on the local network printer 100, the CPU 30 goes through Step S806 to judge whether a network printer 100 which satisfies the printing conditions is available on the Internet 199. If it is found that an appropriate network printer 100 is available on the Internet 199, the CPU 30 goes through Step S808 to judge whether the appropriate network printer 100 is of the same type as the specific network printer 100. If it is found that the appropriate network printer 100 is a different type, the CPU 30 goes through Step S810 to send the acquisition request containing the identifier to the appropriate network printer 100.

When the appropriate network printer 100 receives the acquisition request, the CPU 30 goes through Step S826 to send a print data request to the user terminal 200 by putting the identifier contained in the acquisition request in the print data request.

When the user terminal 200 receives the print data request, the CPU 50 goes through Steps S602 and S604 to search for the appropriate intermediate print data based on the identifier contained in the print data request and send the retrieved intermediate print data to the appropriate network printer 100.

When the appropriate network printer 100 receives the intermediate print data, since the intermediate print data is to be printed on the network printer 100 itself, the CPU 30 goes through Steps S818 and S822 to convert the received intermediate print data into specialized print data and do printing based on the resulting specialized print data.

In this way, according to this embodiment, if a network printer 100 receives specialized print data which contains printing conditions indicating that printing should be done on another network printer 100, it sends an acquisition request containing the identifier of the intermediate print data corresponding to the received specialized print data to the other network printer 100. On the other hand, if the network printer 100 receives specialized print data which contains printing conditions indicating that printing should be done on the network printer 100 itself, it does printing based on the received specialized print data. However, if it receives an acquisition request, it acquires the intermediate print data identified by the identifier contained in the received acquisition request, converts the acquired intermediate print data into specialized print data, and does printing based on the resulting specialized print data.

Thus, once a printer driver for a specific network printer 100 has been installed on the user terminal 200, printing can be done relatively appropriately using a plurality of network printers 100. Also, the need for the user to reconfigure printing conditions can be reduced because the specific network printer 100 transfers the intermediate print data obtained by conversion to another network printer 100. This makes it possible to reduce the time and effort spent on installing printer drivers and save the user the trouble of making settings.

Also, if the printing conditions contained in the received specialized print data indicate that another network printer should be used for printing, the intermediate print data is transferred to the other network printer. This makes it possible to print on a network printer which relatively satisfies user requirements.

Also, since the specialized print data which can be processed in the same format is not converted and only the data that must be processed in a different format is converted into intermediate print data, the number of conversions can be decreased, reducing the processing load of the entire system.

In the fourth embodiment described above, the network printer 100 corresponds to the output device according to aspects 1 and 30; the printing device 42 corresponds to the output section according to aspect 1; and Step S802 corresponds to the specialized output data receiving section according to aspect 1 and specialized output data receiving step according to aspect 30. Also, Step S820 corresponds to the inverse data conversion section according to aspect 1 and inverse data conversion step according to aspect 30, Step S828 corresponds to the intermediate output data receiving section according to aspect 1 and intermediate output data receiving step according to aspect 30 and the specialized print data corresponds to the specialized output data according to aspects 1 and 30.

Also, in the fourth embodiment described above, the intermediate print data corresponds to the intermediate output data according to aspects 1 and 30.

Incidentally, in the first embodiment described above, the network printer 100 is configured to select a network printer 100 which satisfies the printing conditions closest to the printing conditions contained in received print data, convert received specialized print data into intermediate print data, and transfer the intermediate print data to the selected network printer 100, but this is not restrictive. Alternatively, it is possible to judge whether the selected network printer 100 is of the same type as the local network printer 100, and then if it is found that the selected network printer 100 is a different type, the specialized print data may be transferred after conversion into intermediate print data and if it is found that the selected network printer 100 is the same type, the specialized print data may be transferred as it is.

Also, although according to the first to fourth embodiments described above, the processes shown in the flowcharts of FIGS. 3, 8, 15, and 18 are performed according to the control program stored in the ROM 32, this is not restrictive. Alternatively, it is possible to load a program for the procedures from a storage medium into the RAM 34 for execution.

Also, although according to the first to fourth embodiments described above, the processes shown in the flowcharts of FIGS. 7, 9, 11, and 14 are performed according to the control program stored in the ROM 52, this is not restrictive. Alternatively, it is possible to load a program for the procedures from a storage medium into the RAM 54 for execution.

The storage medium here may be of any type, provided it is computer-readable, regardless of whether it is electronic, magnetic, or optical: it may be a semiconductor storage medium such as a RAM or ROM; magnetic storage medium such as an FD or HD; optical storage medium such as a CD, CDV, LD, or DVD; or magneto-optical storage medium such as an MO.

Also, although according to the first to fourth embodiments described above, the output device selection system, printer selection system, output device, program for output device, and output device selection method according to the present invention have been applied to a network system, namely, the Internet 199, this is not restrictive. It is also possible to apply them to so-called intranets which conduct communications by the same method as the Internet 199. Of course, they may also be applied to ordinary networks in addition to the networks which conduct communications by the same method as the Internet 199.

Also, although according to the first to fourth embodiments described above, the output device selection system, printer selection system, output device, program for output device, and output device selection method according to the present invention have been applied to a case in which a printer used for printing is selected from among a plurality of network printers 100 in response to a print request from a user terminal 200, this is not restrictive. They may also be applied to other cases without departing from the scope of the present invention. For example, they may be applied to a case in which a projector used for projection is selected from among a plurality of network projectors in response to a projection request from a user terminal 200.

The entire disclosure of Japanese Patent Application Nos. 2002-377,295 filed Dec. 26, 2002 and 2003-369,239 filed Oct. 29, 2003 are incorporated by reference.

1. An output device selection system which communicably connects a plurality of output devices and selects one of the plurality of output devices to produce output, wherein:
a first output device from among the plurality of output devices comprises a specialized output data receiving section for receiving specialized output data in an output format which can be output by devices of the same type as the first output device, and an output section for producing output based on the specialized output data received by the specialized output data receiving section;
the output device selection system comprises an output device selection section for selecting a destination output device from among the plurality of output devices, and an intermediate output data transfer section for transferring intermediate output data of the specialized output data to the output device selected by the output device selection section; and
a second output device other than the first output device from among the plurality of output devices comprises an intermediate output data receiving section for receiving the intermediate output data, an inverse data conversion section for converting the intermediate output data received by the intermediate output data receiving section into specialized output data in an output format which can be output by devices of the same type as the second output device, and an output section for producing output based on the specialized output data produced by the inverse data conversion section.

2. An output device selection system which communicably connects a plurality of output devices and selects one of the plurality of output devices to produce output, wherein:
a first output device from among the plurality of output devices comprises a specialized output data receiving section for receiving specialized output data in an output format which can be output by devices of the same type as the first output device, a data conversion section for converting the specialized output data received by the specialized output data receiving section into intermediate output data, an output section for producing output based on the specialized output data received by the specialized output data receiving section, an output device selection section for selecting a destination output device from among the plurality of output devices, and an intermediate output data transfer section for transferring the intermediate output data produced by the data conversion section to the output device selected by the output device selection section; and
a second output device other than the first output device from among the plurality of output devices comprises an intermediate output data receiving section for receiving the intermediate output data, an inverse data conversion section for converting the intermediate output data received by the intermediate output data receiving section into specialized output data in an output format which can be output by devices of the same type as the second output device, and an output section for producing output based on the specialized output data produced by the inverse data conversion section.

3. A printer selection system which communicably connects a plurality of network printers and selects one of the plurality of network printers in response to a print request from a print request terminal, wherein:
the network printer comprises a specialized print data receiving section for receiving specialized print data in a print format which can be printed by devices of the same type as the one network printer, a data conversion section for converting the specialized print data received by the specialized print data receiving section into intermediate print data, a network printer selection section for selecting a destination network printer from among the plurality of network printers, an intermediate print data transfer section for transferring the intermediate print data produced by the data conversion section to the network printer selected by the network printer selection section, an intermediate print data receiving section for receiving the intermediate print data, an inverse data conversion section for converting the intermediate print data received by the intermediate print data receiving section into the specialized print data, and a printing section for printing based on at least one of the specialized print data received by the specialized print data receiving section and the specialized print data produced by the inverse data conversion section; and
the data conversion section, the network printer selection section, and the intermediate print data transfer section operate based on predetermined printing conditions.

4. The printer selection system according to claim 3, wherein:
the specialized print data contains the printing conditions;
if the printing conditions contained in the specialized print data received by the specialized print data receiving section indicate that another one of the network printers should be used for printing, the data conversion section, the network printer selection section, and the intermediate print data transfer section operate based on the received printing conditions; and
if the printing conditions contained in the specialized print data received by the specialized print data receiving section indicate that the local network printer should be used for printing, the printing section does printing based on the received specialized print data.

5. The printer selection system according to claim 4, wherein:
if the printing conditions contained in the specialized print data received by the specialized print data receiving section indicate that another one of the network printers should be used for printing, the network printer selection section selects the network printer indicated by the printing conditions from among the plurality of network printers.

6. The printer selection system according to claim 4, wherein:
the printer selection system maintains selection conditions for the network printer; and
the network printer selection section selects a destination network printer from among the plurality of network printers based on the selection conditions.

7. The printer selection system according to claim 5, wherein:
the intermediate print data contains the printing conditions; and
if the printing conditions contained in the intermediate print data received by the intermediate print data receiving section indicate that the local network printer should be used for printing, the inverse data conversion section and the printing section operate based on the received intermediate print data.

8. The printer selection system according to claim 3, wherein:
when transferring print data to the other network printer, the specialized print data is transferred without conversion by the data conversion section if the destination network printer is of the same type as the local network printer.

9. A printer selection system which communicably connects a plurality of network printers with a print request terminal and selects one of the plurality of network printers in response to a print request from the print request terminal, wherein:
the print request terminal comprises an intermediate print data generating section for generating intermediate print data, and an intermediate print data sending section for sending the intermediate print data generated by the intermediate print data generating section to one of the plurality of network printers;
the network printer comprises an intermediate print data receiving section for receiving intermediate print data, an intermediate print data transfer section for transferring the intermediate print data received by the intermediate print data receiving section to another network printer, an inverse data conversion section for converting the intermediate print data received by the intermediate print data receiving section into specialized print data in a print format which can be printed by devices of the same type as the one network printer, and a printing section for printing based on the specialized print data produced by the inverse data conversion section; and
the intermediate print data transfer section operates based on predetermined printing conditions.

10. An output device which communicably connects with a plurality of output devices, comprising:
a specialized output data receiving section for receiving specialized output data in an output format which can be output by devices of the same type as the output device, a data conversion section for converting the specialized output data received by the specialized output data receiving section into intermediate output data, an output section for producing output based on the specialized output data received by the specialized output data receiving section, an output device selection section for selecting a destination output device from among the plurality of output devices, and an intermediate output data transfer section for transferring intermediate output data produced by the data conversion section to the output device selected by the output device selection section.

11. An output device which communicably connects with a plurality of output devices, comprising:
an intermediate output data receiving section for receiving intermediate output data, an inverse data conversion section for converting the intermediate output data received by the intermediate output data receiving section into specialized output data in an output format which can be output by devices of the same type as this output device, and an output section for producing output based on the specialized output data produced by the inverse data conversion section.

12. A computer having a program for an output device which communicably connects with a plurality of output devices, wherein the program makes the computer execute processes to be implemented as:
a specialized output data receiving section for receiving specialized output data in an output format which can be output by devices of the same type as the computer, a data conversion section for converting the specialized output data received by the specialized output data receiving section into intermediate output data, an output device selection section for selecting a destination output device from among the plurality of output devices, and an intermediate output data transfer section for transferring intermediate output data produced by the data conversion section to the output device selected by the output device selection section.

13. A computer having a program for an output device which communicably connects with a plurality of output devices, wherein the program makes the computer execute processes to be implemented as:
an intermediate output data receiving section for receiving intermediate output data, an inverse data conversion section for converting the intermediate output data received by the intermediate output data receiving section into specialized output data in an output format which can be output by devices of the same type as the computer.

14. An output device selection method for communicably connecting a plurality of output devices and selecting one of the plurality of output devices to produce output, wherein:
for a first output device from among the plurality of output devices, the output device selection method comprises:
a specialized output data receiving step of receiving specialized output data in an output format which can be output by devices of the same type as the first output device, and
an output step of producing output based on the specialized output data received by the specialized output data receiving step;
the output device selection method further comprises:
an output device selection step of selecting a destination output device from among the plurality of output devices, and an intermediate output data transfer step of transferring intermediate output data of the specialized output data to the output device selected by the output device selection step; and
for a second output device other than the first output device from among the plurality of output devices, the output device selection method comprises:
an intermediate output data receiving step of receiving the intermediate output data,
an inverse data conversion step of converting the intermediate output data received by the intermediate output data receiving step into specialized output data in an output format which can be output by devices of the same type as the second output device, and
an output step of producing output based on the specialized output data produced by the inverse data conversion step.

15. An output device selection method for communicably connecting a plurality of output devices and selecting one of the plurality of output devices to produce output, wherein:
for a first output device from among the plurality of output devices, the output device selection method comprises:
a specialized output data receiving step of receiving specialized output data in an output format which can be output by devices of the same type as the first output device,
a data conversion step of converting the specialized output data received by the specialized output data receiving step into intermediate output data if the specialized output data received by the specialized output data receiving step is to be output from another output device,
an output device selection step of selecting a destination output device from among the plurality of output devices,
an intermediate output data transfer step of transferring the intermediate output data produced by the data conversion step to the output device selected by the output device selection step, and
an output step of producing output based on the specialized output data received by the specialized output data receiving step if the specialized output data received by the specialized output data receiving step is to be output from the first output device; and
for a second output device other than the first output device from among the plurality of output devices, the output device selection method comprises:
an intermediate output data receiving step of receiving the intermediate output data,
an inverse data conversion step of converting the intermediate output data received by the intermediate output data receiving step into specialized output data in an output format which can be output by devices of the same type as the second output device, and
an output step of producing output based on the specialized output data produced by the inverse data conversion step.
